(19) United States
(12) Patent Application Publication
(10) Pub. No.: US 2025/0126462 A1
(43) Pub. Date: Apr. 17, 2025

(54) MECHANISM TO ALLEVIATE UNDERUTILIZED COMPUTING, SENSING, CONNECTIVITY, AND ENERGY CAPABILITIES

(71) Applicant: QUALCOMM Incorporated, San Diego, CA (US)

(72) Inventors: Sudeepto ROY, Del Mar, CA (US); Ramesh C.N RAO, San Diego, CA (US)

(21) Appl. No.: 18/444,309

(22) Filed: Feb. 16, 2024

Related U.S. Application Data
(60) Provisional application No. 63/590,240, filed on Oct. 13, 2023.

(51) Int. Cl. H04W 8/24; H04W 76/10

(52) U.S. Cl. CPC H04W 8/24; H04W 76/10

(57) ABSTRACT

Disclosed are systems, apparatuses, processes, and computer-readable media for wireless communications. For example, a first device can transmit, to one or more second devices, an advertisement message indicating one or more capabilities of the first device available for sharing with the one or more second devices. The first device can receive, from at least one second device of the one or more second devices, a response message requesting at least one capability of the one or more capabilities from the first device. The first device can establish a connection with the at least one second device for sharing the at least one capability.

### CROSS-REFERENCE TO RELATED APPLICATION

This application claims the benefit of, and priority to, U.S. Provisional Application No. 63/590,240, filed Oct. 13, 2023, which is hereby incorporated by reference, in its entirety and for all purposes.

### FIELD

The present disclosure generally relates to communications by connected devices (e.g., wireless communications via a wireless interface, or other types of communications, such as via a universal serial bus (USB) interface, via a network-on-chip (NOC) interface, via a high-speed interface, etc.). For example, aspects of the present disclosure relate to a mechanism to alleviate underutilized capabilities, such as computing capabilities, sensing capabilities, connectivity capabilities, energy capabilities, any combination thereof, and/or other capabilities.

### BACKGROUND

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods, and computer-readable media for a mechanism to alleviate underutilized capabilities, such as computing capabilities, sensing capabilities, connectivity capabilities, energy capabilities, any combination thereof, and/or other capabilities that can be shared between devices.

According to at least one example, a first device for sharing device capabilities is provided. The first device includes at least one memory and at least one processor coupled to the at least one memory. The at least one processor is configured to: output, for transmission to one or more second devices, an advertisement message indicating one or more capabilities of the first device available for sharing with the one or more second devices; receive, from at least one second device of the one or more second devices, a response message requesting at least one capability of the one or more capabilities from the first device; and establish a connection with the at least one second device for sharing the at least one capability.

In another illustrative example, a method is provided for sharing device capabilities at a first device. The method includes: transmitting, by a first device to one or more second devices, an advertisement message indicating one or more capabilities of the first device available for sharing with the one or more second devices; receiving, by the first device from at least one second device of the one or more second devices, a response message requesting at least one capability of the one or more capabilities from the first device; and establishing, by the first device, a connection with the at least one second device for sharing the at least one capability.

In another illustrative example, a non-transitory computer-readable medium of a first device is provided that includes stored thereon instructions that, when executed by one or more processors, cause the one or more processors to: output, for transmission to one or more second devices, an advertisement message indicating one or more capabilities of the first device available for sharing with the one or more second devices; receive, from at least one second device of the one or more second devices, a response message requesting at least one capability of the one or more capabilities from the first device; and establish a connection with the at least one second device for sharing the at least one capability.

In another illustrative example, a first device for sharing device capabilities is provided. The first device includes: means for transmitting, to one or more second devices, an advertisement message indicating one or more capabilities of the first device available for sharing with the one or more second devices; means for receiving, from at least one second device of the one or more second devices, a response message requesting at least one capability of the one or more capabilities from the first device; and means for establishing a connection with the at least one second device for sharing the at least one capability.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example of a wireless communication network, in accordance with some examples;

FIG. 2 is a diagram illustrating a design of a base station and a user equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a UE, in accordance with some examples;

FIG. 5 is a diagram illustrating an example of a process for alleviating (e.g., via sharing) underutilized computing, sensing, connectivity, and/or energy capabilities, in accordance with some examples;

FIG. 6 is a table illustrating examples of attributes for sharing underutilized computing, sensing, connectivity, and/or energy capabilities, in accordance with some examples;

FIG. 7 is a diagram illustrating an example of a system including devices with permanent associations with each other, in accordance with some examples;

FIG. 8 is a diagram illustrating an example of a system including devices with ad hoc associations with each other, in accordance with some examples;

FIGS. 9A and 9B are tables that together illustrate examples of capabilities for sharing amongst devices, in accordance with some examples;

FIG. 10 is a diagram illustrating an example of signaling for devices with permanent associations for sharing capabilities and resources, in accordance with some examples;

FIG. 11 is a diagram illustrating an example of signaling for devices with permanent associations for exchanging data, in accordance with some examples;

FIG. 12 is a diagram illustrating an example of signaling for devices with ad hoc associations for sharing capabilities and resources, in accordance with some examples;

FIG. 13 is a diagram illustrating an example of signaling for devices with ad hoc associations for exchanging data, in accordance with some examples;

FIG. 14 is a flow diagram illustrating an example of a process for wireless communications, in accordance with some examples; and

FIG. 15 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Communication networks can be deployed to provide various communication services, such as voice, video, packet data, messaging, broadcast, any combination thereof, or other communication services. Communication networks include wireless and wired communication networks. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP evolved multimedia broadcast multicast service (eMBMS) base station, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE. In another example, a wireless communication network may support a downlink-only service capable communication device, which can act as a receiver for information, such as video, data, broadcast, multicast messages, etc. from a base station/transmitter system. Other types of wireless communication networks include broadcast communications systems (e.g., 5G broadcast (5 GB), Bluetooth™ communication networks, Ultra-Wideband (UWB) communication networks, Near-Field Communications (NFC) networks, among others. Other types of communications include communications via a universal serial bus (USB) interface, via a network-on-chip (NOC) interface, via a high-speed interface, among others.

At the beginning of the year 2023, as per industry reports, there were approximately 5.3 billion (B) internet connected users (e.g., which makes up approximately 66 percent of the global population), representing 29.3B or 3.6 per capita of connected devices. Assuming a conservative compound annual growth rate (CAGR) estimate of 10 percent per year during the years of 2024 to 2030, the world will see approximately 51B or about 5.6 per capita connected devices, at the turn of this decade.

While many of these devices will be gainfully utilized to meet numerous consumer, industrial, and societal needs, the reality is that collective computing (e.g., on devices in permanent and ad hoc networks), sensing, connectivity, and energy capabilities of these connected devices will lie grossly underutilized. With increasing costs of advanced devices and a long-term adequacy of capabilities of those devices, replacement cycles have slowed down. Furthermore, many devices, once installed in permanent fixtures, will rapidly fall behind the capabilities of the latest devices and will not be readily replaced, due to prohibitively high costs of replacement and reinstallation. Mobile devices, such as smartphones, also generate useful data, such as in multimedia or sensor data formats, which may also be shareable in permanent and ad-hoc networks.

These and other factors give rise to the need for a collaborative mobile edge compute and communications mechanism that could collaboratively identify and use the best available compute, connectivity, sensing, storage, energy, hardware, among other resources within an association of devices, while managing overall battery energy consumption, privacy, and data security.

In one or more aspects of the present disclosure, systems, apparatuses, methods (also referred to as processes), and computer-readable media (collectively referred to herein as “systems and techniques”) are described herein that provide solutions for a mechanism to alleviate (e.g., via sharing) underutilized computing, sensing, connectivity, and energy capabilities. In some aspects, systems and techniques are provided to collaboratively identify and use the best available capabilities (e.g., compute capabilities, sensing capabilities, connectivity and/or communication capabilities, energy capabilities, any combination thereof, and/or other capabilities that can be shared between devices) and services within an association of devices, while managing the overall energy consumption and data security and, in some cases, using an exchange system (e.g., a digital e-token value based exchange system) and/or reputation score system.

While particular capabilities and services are described herein, such capabilities and services are provided as illustrative examples and are not limited thereto. The systems and techniques can be used for other types of capabilities and services, such as power (e.g., battery) resources, memory and/or storage resources, sharing of specific hardware components or blocks (e.g., hardware components or blocks on a system-on-chip (SoC), such as a Graphics Processing Unit (GPU), a Neural Processing Unit (NPU), internal Cache memory, etc.), and/or other capabilities or services.

In one or more examples, collaborative associations (e.g., a device group association, such as a permanent association or an ad hoc association) are employed to provide a superior aggregate computing, connectivity, sensitivity, and energy management experience than provided by the individual devices alone. In some examples, these collaborative associations can utilize device and data reputation scores (e.g., which may be based on usage levels and/or ratings) in combination with an exchange system (e.g., a digital e-token value based exchange system). In some examples, the exchange system can have pre-granted (e.g., also known as open or free), barter, or charge-based modes. In one or more examples, embedding such a mechanism within heterogenous devices early and pervasively can give rise to capabilities for monetizing mobile edge compute applications and devices.

The disclosed methodology can be beneficial to allow multiple types and classes of mobile edge compute devices within an association or a cluster to identify, broadcast, and collaboratively share their capabilities and/or services (e.g., compute capabilities, sensing capabilities, connectivity and/or communication capabilities, energy capabilities, power capabilities, battery capabilities, storage and/or memory capabilities, hardware capabilities, any combination thereof, and/or other capabilities that can be shared between devices). Such sharing of capabilities and/or services can enable use of the best available resources for a given task, access capabilities that are unavailable locally (e.g., within a device), fully deploy under-utilized computing resources, conserve depleted battery charge by offloading energy-intensive computing tasks, enhance security of local data, reduce power consumption, optimize network utilization, sharing capabilities, resources, and/or data (e.g., multimedia data and/or sensor data) based on utilization of a reputation score and/or an exchange system, among other benefits. This robust data sharing mechanism can allow for monetization of the data and/or capability set by bartering, charging, or making available for free. Such data sharing can include private sharing and/or public sharing (e.g., “renting” out best camera capabilities in a sports stadium, etc.; or “renting” out hotspot capabilities in mass transit, etc.).

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, artificial intelligence (AI) capable edge-compute device such as AI processing capable and/or inference processor, intelligent edge-compute devices, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, a network device, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node (or device) may be described as being configured to transmit information to a second network node (or device). In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network nodes can include a homogenous air interface and/or a mixed mode/heterogenous air interface for the overall network. For instance, network nodes including a homogenous air interface can include devices that can communicate using a same protocol/language (e.g., cellular, ethernet, WiFi, Bluetooth™, USB, etc.). Network nodes including a mixed mode or heterogenous air interface can include devices that can communicate using more than one of the protocols/languages that are represented in the overall shared network (e.g., cellular, ethernet, WiFi, Bluetooth™, USB, etc.).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

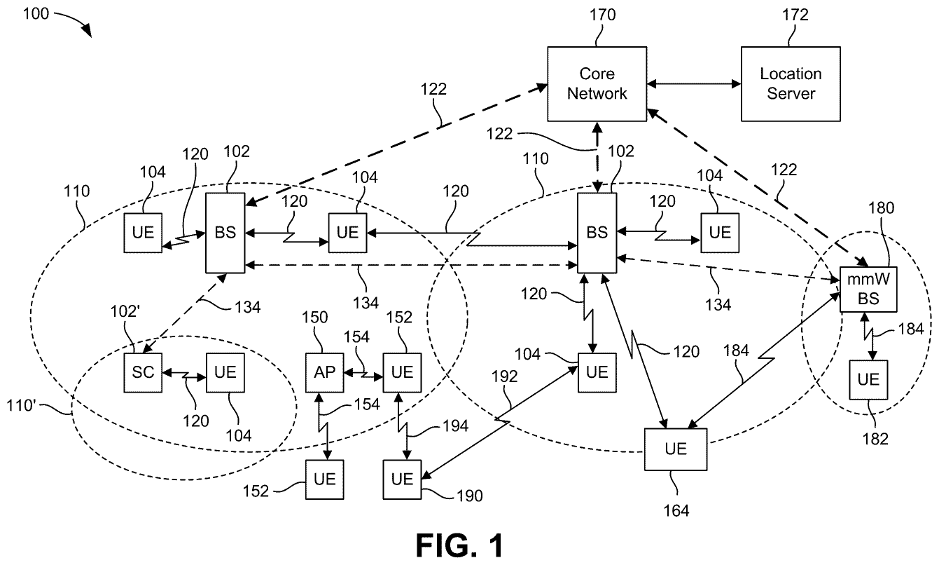

Various aspects of the systems and techniques described herein will be discussed below with respect to the figures. According to various aspects, FIG. 1 illustrates an example of a wireless communications system 100, in accordance with some aspects of the present disclosure. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHZ (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

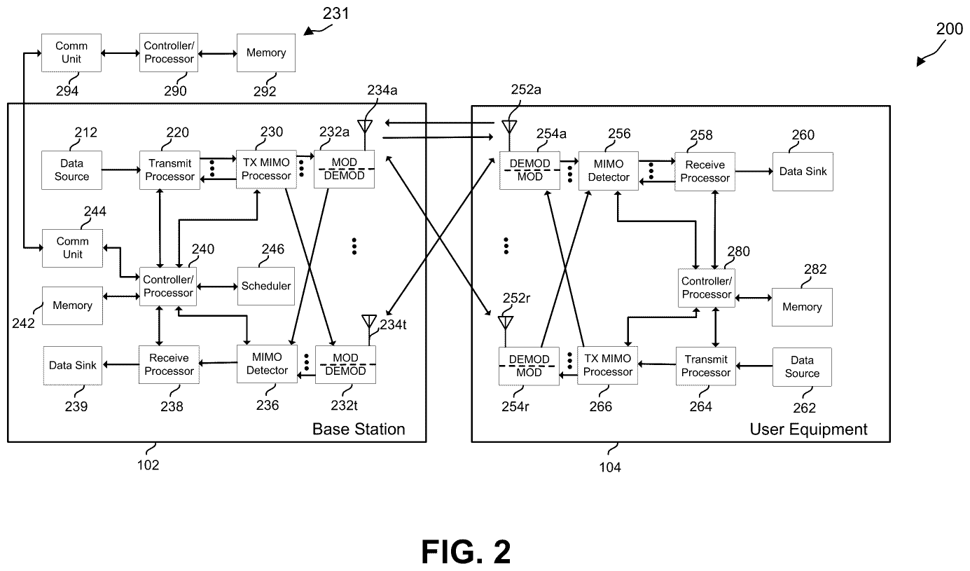

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, e.g., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

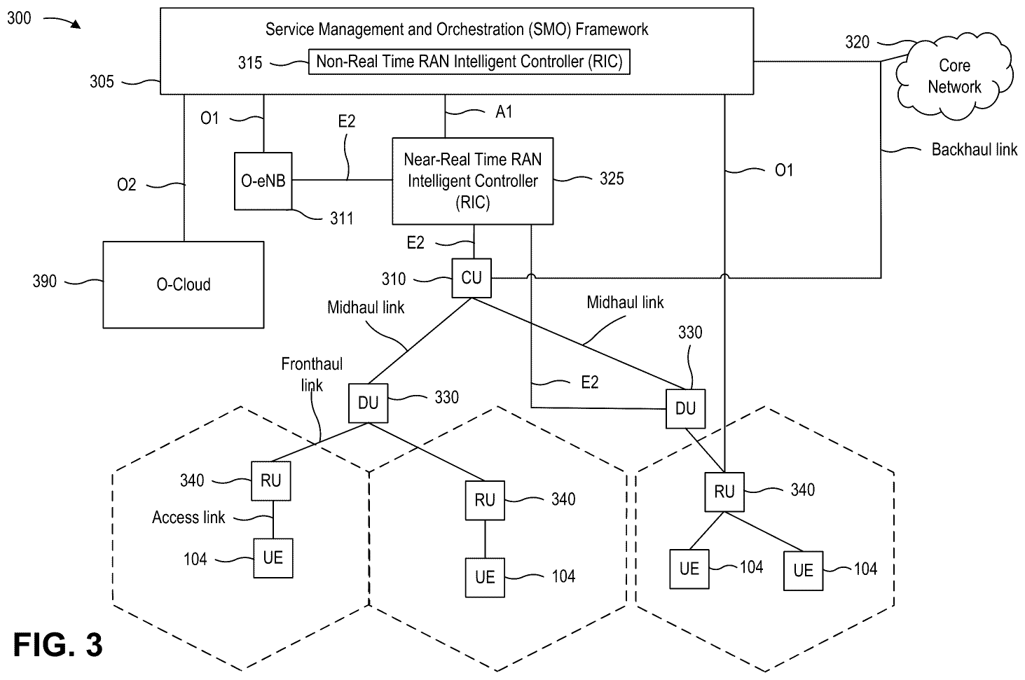

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUS 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training, Large Multi-Modal Models, including customizations and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via 01) or via creation of RAN management policies (e.g., such as A1 policies).

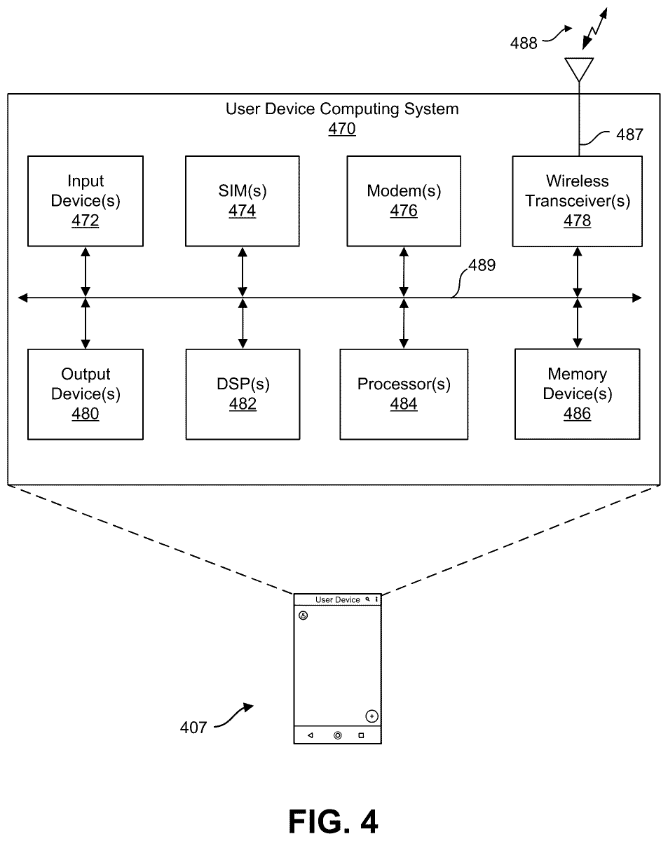

FIG. 4 illustrates an example of a computing system 470 of a wireless device 407, in accordance with some aspects of the present disclosure. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smartwatch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

As previously mentioned, at the beginning of the year 2023, as per industry reports, there were approximately 5.3B internet connected users, which are approximately 66 percent of the global population, representing 29.3B or 3.6 per capita of connected devices. Assuming a conservative CAGR estimate of 10 percent per year during the years of 2024 to 2030, there should be approximately 51B or about 5.6 per capita connected devices, at the turn of this decade.

While many of these devices will be utilized to meet numerous consumer, industrial, and societal needs, the collective computing (e.g., on devices in permanent and ad hoc networks), sensing, connectivity, and energy capabilities of these connected devices will be grossly underutilized. With increasing costs of advanced devices and a long-term adequacy of capabilities of those devices, replacement cycles have slowed down. Moreover, many devices, once installed in permanent fixtures, will rapidly fall behind the capabilities of the latest devices and will not be readily replaced, due to prohibitively high costs of replacement and reinstallation. Mobile devices (e.g., such as smartphones) also generate useful data, such as in multimedia or sensor data formats, which may also be shareable in permanent and ad-hoc networks.

As such, there is a need for a collaborative mobile edge compute and communications mechanism that could collaboratively identify and use the best available compute, connectivity, and sensing technologies within an association of devices, while managing overall battery energy consumption, privacy, and data security.

In one or more aspects, the systems and techniques provide a mechanism to alleviate (e.g., via sharing) underutilized computing, sensing, connectivity, and energy capabilities of devices. In some aspects, the systems and techniques can collaboratively identify and use the best available compute, connectivity, sensing technologies, and other capabilities and services within an association of devices, while managing the overall energy consumption and data security. Collaborative associations (e.g., device group associations, such as a permanent association or an ad hoc association) are employed to provide a superior aggregate computing, connectivity, sensitivity, and energy management experience than provided by the individual devices alone. These collaborative associations may utilize device and data reputation scores (e.g., which can be based on usage levels and/or ratings) in combination with an exchange system (e.g., a digital e-token value based exchange system). The exchange system can have pre-granted (e.g., also known as open or free), barter, or charge-based modes. Embedding such a mechanism within heterogenous devices early and pervasively can give rise to capabilities for monetizing mobile edge compute applications and devices.

The systems and techniques can allow for multiple types and classes of mobile edge compute devices within an association or a cluster to identify, broadcast, and collaboratively share their compute, sensing, and communication capabilities to enable use of the best available resources for a given task, access capabilities that are unavailable locally (e.g., within a device), fully deploy under-utilized computing resources, conserve depleted battery charge by offloading energy-intensive computing tasks, enhance security of local data, reduce power consumption, and optimize network utilization.

The systems and techniques can use different sets of capabilities (e.g., compute capabilities, sensing capabilities, connectivity and/or communication capabilities, energy capabilities, power (e.g., battery) capabilities, memory and/or storage capabilities, hardware capabilities such as hardware components or blocks on a system-on-chip (SoC), any combination thereof, and/or other capabilities) to produce an aggregate sense of both individual device capabilities and the overall associations collective capabilities. The systems and techniques also unify heterogenous types of devices, depending upon the type of device group association (e.g., a permanent association or an ad hoc association) of the devices. The systems and techniques additionally rely on the concept of permanent, semi-permanent, and transitory associations that battery-powered devices encounter during their service lifetime. By having this robust mechanism in place, the device association provider can also monetize the capability set in numerous ways, such as for cases of private sharing or public sharing (e.g., such as for renting out best camera capabilities in a sports stadium, or renting out hotspot capabilities in mass transit, etc.).

The systems and techniques have multiple advantages that may include, but are not limited to, enabling the use of the best available resources for a given task, accessing capabilities that are unavailable locally (e.g., within a device), fully deploying under-utilized computing resources, conserving a depleted battery charge by offloading energy-intensive computing tasks, enhancing the security of local data, reducing the power consumption, optimizing the network utilization, sharing capabilities, resources, and/or data (e.g., multimedia data and/or sensor data) based on utilization of a reputation score and/or an exchange system, any combination thereof, and/or other capabilities and/or services.

The systems and techniques address a number of issues that may arise from these many deployed devices. For a first issue, with the large-scale proliferation of “connected” and “compute”, including “edge-AI” devices utilized for personal needs, home environments, work and study environments, transportation and transit environments, and other avenues of mass public congregation, the aggregate computation or device capabilities and connectivity bandwidth often remain underutilized, despite the devices being in proximity or associated within a permanent trust association (e.g., such as for devices located within the home environment) or a temporary association (e.g., an ad hoc association, such as for devices associated with passengers traveling on a bus or within an airplane). For a second issue, devices may often have capability variations or position disadvantages that may be alleviated by other devices located within proximity (e.g., within a sports stadium, only a few spectators have the best viewing angles, and among such spectators, their associated smartphones may not have adequate camera capabilities, such as super-zoom video and/or image stability capabilities). For a third issue, often, people may find themselves located in proximity of battery-operated devices with unequal levels of remaining battery charge (e.g., at the end of a day-trip, a charge-depleted smartphone or smartwatch may be located in proximity to a well-charged laptop computer), leading to frustration of battery anxiety regarding a small subset of devices (e.g., smartphone and/or smartwatch). Another aspect of this issue is unequal usage of devices leading to rapid battery depletion (e.g., overuse of a smartphone's compute and connectivity capabilities despite being located in proximity of a personal computer with an internet connection and wall-powered charge). For a fourth issue, within a trusted association (e.g., a permanent association) of devices, some devices may have limited compute capabilities that would limit the sophistication of overall algorithms that could otherwise be run in a distributed or heterogeneous manner over other capable devices within the association. Similarly, devices within an association may often need to sense and compute data collaboratively within themselves, instead of resorting to cloud processing, to keep the data secure. As such, key aspects of the systems and techniques are to collaboratively identify and use the best available compute, connectivity, sensing technologies, and other capabilities and services within an association of devices, while managing the overall energy consumption and data security and, in some cases, using an exchange system (e.g., a digital e-token value-based exchange system) and/or reputation score system.

In one or more examples, the systems and techniques are applicable for devices in associations (e.g., device group associations) in a variety of different environments, such as within permanent associations and ad hoc associations. In one or more examples, permanent associations may include a personal device association (e.g., which may include body worn, body-carried, and/or body proximity devices or personal transportation devices), a friends and family association (e.g., which may include devices in proximity of devices belonging to trusted friends and/or relatives), and/or a home device association (e.g., which may include devices at home, such as devices with a preponderance of consumer electronics). In some examples, ad hoc associations may include a workplace environment association (e.g., which may include devices within offices, classrooms, factories, hospitals, and/or military installations) and/or a public congregation association (e.g., which may include devices located at transportation hubs, mass transit systems, sports venues, concerts, conventions, malls, marketplaces, fairs, and/or religious services at religious institutions).

In one or more aspects, personal devices associated with a user may enroll within a trusted association (e.g., a personal device association). Once enrolled, these personal devices may have a high reputation score (e.g., a high level of trustworthiness) for sharing their capabilities, a pre-granted exchange system (e.g., an already established system) for sharing their capabilities, a high reputation score for sharing their acquired (e.g., sensed) data (e.g., images or video data), and a pre-granted exchange system for sharing their acquired data. Personal devices associated with the user may include, but are not limited to, a smartphone, a smartwatch, a smart fitness band, a smart audio microphone and headset, a tablet computer, and/or a laptop computer.

Personal devices associated with a user may have capabilities that are underutilized, and may be share these underutilized capabilities with other personal devices associated with the user. In one or more examples, a personal device associated with a user may have an underutilized best device capability. For example, a user is walking along a busy street talking on a call via the user's audio headset device, and the user's audio headset device detects background street noise. The user's audio headset device may request the user's smartphone to run an advanced noise cancellation algorithm to clean up the person's speech in the call prior to the transmission of the audio. In some examples, a personal device associated with a user may have an underutilized best connectivity capability. For example, a user's laptop, upon recognizing that the user's nearby 5G phone has much faster connectivity, may switch to connecting to the phone's hotspot.

In one or more examples, a personal device associated with a user may have a position disadvantage. For example, a user's laptop, which is on a video call with low lighting conditions, can automatically request “camera assistance” from the user's more capable smartphone and can use the smartphone's camera instead of its own camera. In some examples, a personal device associated with a user may have an underutilized energy capability. For example, a user's smartphone, upon realizing its battery has a low remaining charge, can switch to a power-saving Bluetooth connection with the user's adjacent laptop and can leverage the laptop's internet connection. In one or more examples, a personal device associated with a user may utilize collaborative computing. For example, a user's smartwatch or fitness band can conserve energy by taking vital readings and relying on a paired user's smartphone for overall computation of the exercise exertion levels or medical condition assessment, which in turn can direct the smartwatch's next set of readings (e.g., per the exercise regimen or medical algorithm).

In one or more aspects, personal devices associated with multiple users (e.g., users that are friends and/or family with each other) that trust each other may enroll within a trusted association (e.g., a friends and family association). Once enrolled, these personal devices may have a high reputation score (e.g., a high level of trustworthiness) for sharing their capabilities with each other, a pre-granted exchange system (e.g., an already established system) for sharing their capabilities, a high reputation score for sharing their acquired (e.g., sensed) data (e.g., images or video data) with each other, and a pre-granted exchange system for sharing their acquired data. Personal devices associated with these users may include, but are not limited to, a smartphone, a smartwatch, a smart fitness band, a smart audio microphone and headset, a tablet computer, and/or a laptop computer.

Personal devices associated with these users (e.g., friends and family users) may have capabilities that are underutilized, and may be share these underutilized capabilities with other personal devices associated with these users. In one or more examples, a personal device associated with one of these friends and family users may have an underutilized best device capability. For example, a superior Android-based camera of a first user's Android smartphone device may be shared with a second user's iOS smartphone device, while utilizing a superior iOS application (apps) with a Windows based device. In one or more examples, a personal device associated with one of these friends and family users may have an underutilized best connectivity capability. For example, a first user's iOS smartphone device, upon recognizing a second user's Android smartphone's superior Wi-Fi and cellular capability, may link to (e.g., share with) the second user's Android smartphone.

In some examples, a personal device associated with one of these friends and family users may have a position disadvantage. For example, a trusted group of users (e.g., users within a friends and family association) traveling together can use the camera capabilities of one user in the party who is most advantageously positioned with regard to an object and/or a scene of interest. In one or more examples, a personal device associated with one of these friends and family users may have an underutilized energy capability. For example, a first user's smartphone, upon realizing it has a low remaining battery charge, can switch to a power-saving Bluetooth connection with an adjacent second user's laptop, and can leverage the laptop's internet connection, across multiple users within the trust group. In one or more examples, a personal device associated with one of these friends and family users may utilize collaborative computing. For example, an elderly parent or a sick child's health band can be collaboratively accessed by multiple care givers, and can rely on vitals readings from the band, while running advanced diagnostics and historical reading comparisons on more capable, trusted devices.

In one or more aspects, personal and at home devices associated with multiple users within a family unit may enroll within a trusted association (e.g., a home device association). Once enrolled, these personal and at home devices may have a high reputation score (e.g., a high level of trustworthiness) for sharing their capabilities with each other, a pre-granted exchange system (e.g., an already established system) for sharing their capabilities, a high reputation score for sharing their acquired (e.g., sensed) data (e.g., images or video data) with each other, and/or a pre-granted exchange system for sharing their acquired data. Personal and at home devices associated with these users of a family unit may include, but are not limited to, a smartphone, a smartwatch, a smart fitness band, a smart audio microphone and headset, a tablet computer, a laptop computer, an artificial intelligence (AI)/machine learning (ML) capable edge-compute device, a smart television, a personal computer, a gaming controller, a television remote control, a smart camera, a smart light bulb, a smart pet collar, and/or a computer router.

Personal and at home devices associated with users in a family unit may have capabilities that are underutilized, and may be share these underutilized capabilities with other personal or at home devices associated with the users in the family unit. In one or more examples, a personal or at home device associated with users in a family unit may have an underutilized best device capability. For example, a smartphone associated with a user in a family unit can automatically detect that more than one person (e.g., user) at home is watching the screen on the smartphone and can subsequently switch its display to a nearby television monitor in the home. In one or more examples, a personal or at home device associated with users in a family unit may have an underutilized best connectivity capability. For example, in areas of weak Wi-Fi coverage, devices at home can automatically evaluate nearby devices at home with stronger internet coverage and can establish a Bluetooth or Wi-Fi direct connection with those devices.

In some examples, a personal or at home device associated with users in a family unit may have a position disadvantage. For example, a laptop in the home with weak Wi-Fi coverage, in proximity of a 5G phone in the home with good cellular coverage, can switch its internet connection through the phone. In one or more examples, a personal or at home device associated with users in a family unit may have an underutilized energy capability. For example, a smartphone in the home, upon realizing its low remaining battery charge, can switch to a power-saving Bluetooth connection with an adjacent laptop in the home and can leverage the laptop's internet connection. In one or more examples, a personal or at home device associated with users in a family unit may utilize collaborative computing. For example, a collaborative algorithm, and/or collaborated AI/ML model (e.g., a neural network model or other type of AI/ML model), can run on at home devices to ensure that all of the devices have updated to the latest firmware and have protection from virus vulnerability. For another example, multiplayer games can be enabled to operate in conjunction with a console, a smartphone, and/or a laptop computer within the home.

In one or more aspects, personal and office devices associated with multiple users in an workplace environment (e.g., office, factory, hospital, or military base) may enroll within a trusted association (e.g., a workplace environment association). Once enrolled, these personal and office devices may have a medium to high reputation score (e.g., a medium level to high level of trustworthiness) for sharing their capabilities with each other, a barter (e.g., trade for capabilities) or charge (e.g., pay for capabilities) exchange system for sharing their capabilities, a medium to high reputation score for sharing their acquired (e.g., sensed) data (e.g., images or video data) with each other, and/or a barter or charge exchange system for sharing their acquired data. Personal and office devices associated with the workplace environment may include, but are not limited to, a smartphone, a smartwatch, a smart fitness band, a smart audio microphone and headset, a tablet computer, a laptop computer, a smart television, a personal computer, a smart camera, a smart light bulb, a smart copy machine, a smart facsimile machine, a smart badge, a smart security system, a smart lock, a smart air conditioner, a smart heater, a smart computer monitor, and/or a computer router.

Personal and office devices associated with an office environment may have capabilities that are underutilized, and may be share these underutilized capabilities with other personal or office devices associated with the office environment. In one or more examples, a personal or office device associated with an office environment may have an underutilized best device capability. For example, in a collaborative work environment, employee (e.g., user) and on-premise (e.g., office) devices can automatically switch to the best available cloud compute capabilities based on their proximity, building location, permissions, etc. In one or more examples, a personal or office device associated with an office environment may have an underutilized best connectivity capability. For example, in a collaborative work environment, employee and on-premise devices can be automatically switched to best available connectivity based on proximity to either Wi-Fi or cellular connectivity.

In some examples, a personal or office device associated with an office environment may have a position disadvantage. For example, dead-spots or weak cellular or Wi-Fi coverage areas can be collaboratively mitigated through peer-to-peer association with nearby devices with better coverage. In one or more examples, a personal or office device associated with an office environment may have an underutilized energy capability. For example, mobile devices with a low battery charge can switch from cellular or Wi-Fi to Bluetooth coverage (or other lower power connectivity) to nearby connected devices with an adequate battery charge (e.g., which can be extremely useful in a hospital or military setting). In one or more examples, a personal or office device associated with an office environment may utilize collaborative computing. For example, legacy equipment (e.g., old security cameras) can be collaboratively connected to a nearby device with a compute capacity that can run vision algorithms (e.g., for security, identification, and/or badging applications) without needing the use of new smart cameras.

In one or more aspects, personal devices associated with multiple users (e.g., a group of strangers) in a public congregation environment (e.g., an event, a convention, or a shared public space, such as within a public bus) may collaborate in an ad hoc association (e.g., a public congregation association). These personal devices may have a low to medium reputation score (e.g., a low level to medium level of trustworthiness) for sharing their capabilities with each other, a barter (e.g., trade for capabilities) or charge (e.g., pay for capabilities) exchange system for sharing their capabilities, a low to medium reputation score for sharing their acquired (e.g., sensed) data (e.g., images or video data) with each other, and/or a barter or charge exchange system for sharing their acquired data. Personal devices associated with users within the public congregation environment may include, but are not limited to, a smartphone, a smartwatch, a smart fitness band, a smart audio microphone and headset, a tablet computer, and/or a laptop computer.

Personal devices associated with users within a public congregation environment may have capabilities that are underutilized, and may be share these underutilized capabilities with other personal devices associated with other users within the public congregation environment. In one or more examples, a personal device associated with a user within a public congregation environment may have an underutilized best device capability. For example, a smartphone with better camera capabilities than other smartphones within a crowd could temporarily share its images and/or videos with the other smartphones in the crowd. In one or more examples, a personal device associated with a user within a public congregation environment may have an underutilized best connectivity capability. For example, in areas of weak internet access, devices can automatically establish Bluetooth and/or Wi-Fi connections with nearby devices with stronger internet coverage.

In some examples, a personal device associated with a user within a public congregation environment may have a position disadvantage. For example, in a crowded sports stadium, one spectator with a device may have the best viewing angle and shots from a camera of the device that could be shared with other devices within the stadium. For another example, a device can utilize its cellular connectivity advantage based on the device's line-of-sight (LOS) or best signal strength from a cell tower with another device that has weak cellular coverage. For yet another example, a 5G capable device could share its communication capabilities with nearby 2G or 3G devices. In one or more examples, a personal device associated with a user within a public congregation environment may have an underutilized energy capability. For example, a smartphone, upon realizing its low remaining battery charge, can switch to a power-saving Bluetooth connection with adjacent phones and can leverage those devices' internet connection for sending out critical messages. In one or more examples, a personal device associated with a user within a public congregation environment may utilize collaborative computing. For example, a collaborative algorithm that runs on multiple devices in a temporary association can alert users to threats (e.g., alert regarding someone with a known COVID infection) or emergencies (e.g., alert regarding a senior citizen suddenly falling down). For another example, kids traveling within a school bus could have their overall position shared from the most capable and/or charged device on the bus.

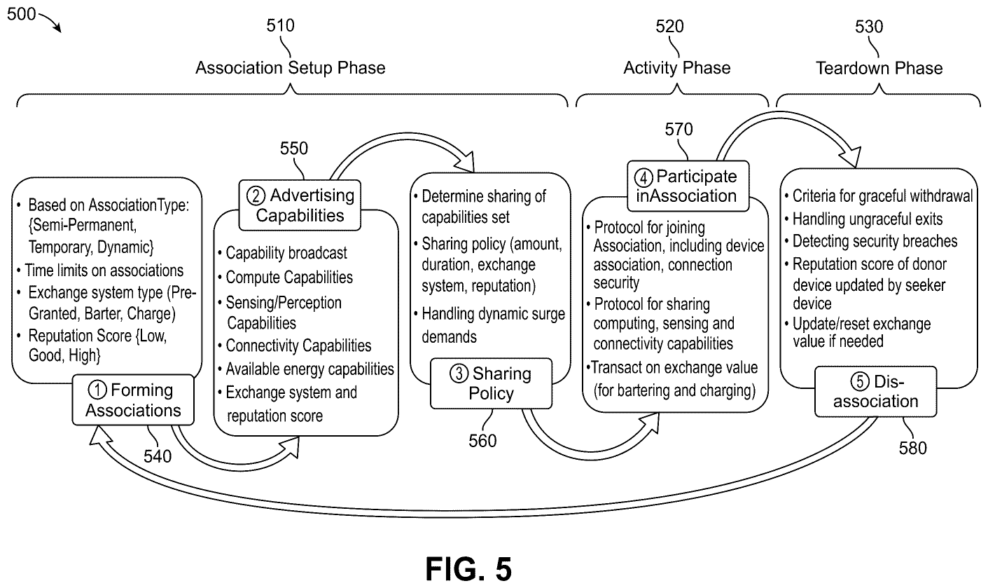

FIG. 5 shows an example of a process for sharing capabilities. In particular, FIG. 5 is a diagram illustrating an example of a process 500 for alleviating (e.g., via sharing) underutilized computing, sensing, connectivity, energy, battery, storage, hardware, and/or other capabilities. In FIG. 5, the process 500 is shown to have three phases, which are an association setup phase 510, an activity phase 520, and a teardown phase 530.

During operation of the process 500, during the forming associations step 540 of the association setup phase 510, a device (e.g., a donor device, such as a network device, for example a smartphone) may transmit (e.g., broadcast) to one or more other devices (e.g., seeker devices, such as network devices, for example smartphones) an association message (e.g., a signal) indicating that the device (e.g., donor device) would like to participate with the other devices (e.g., seeker devices) within an association (e.g., a device group association, which is an association including a group of devices, such as network devices) for sharing capabilities. In one or more examples, the association may be a semi-permanent association, a temporary association, and/or a dynamic association. The association message may also indicate a time limit for the device (e.g., donor device) to participate within the association. For example, in the case where the device is within a mass transit scenario, the time limit may be specified to expire at the end of the bus or train ride.

The association message may also indicate an exchange system to be used for the sharing of the capabilities. In some cases, the exchange system may be a pre-granted exchange system. A pre-granted exchange system may be where the sharing of capabilities amongst devices within an association (e.g., a home device association) has already been previously granted and there is no exchange of currency for using the capabilities. For example, devices located within a home, which are in a home device association, may have been pre-granted for the sharing of their capabilities with each other.

In one or more cases, the exchange system may be a barter exchange system, where devices can trade (e.g., exchange) their capabilities with each other. For example, when two devices are located in different areas of a stadium at a football game, each of the devices can send to the other device an image of the game taken (e.g., captured) from a different vantage point within the stadium. In some cases, the exchange system may be a charge exchange system, where a first device's user may pay a second device's user a fee (e.g., in the form of currency) for using capabilities from the second device. For example, a user of a device with a 5G millimeter wave capability may provide a mobile hot spot to other nearby devices for a fee.

The association message may also indicate a reputation score for the device (e.g., donor device) transmitting the association message. The reputation score can indicate a level of trustworthiness of the device (e.g., donor device). In one or more examples, other devices, which have previously shared and/or received capabilities from the device, may have assigned the reputation score for the device. In one or more examples, the reputation score may be a low reputation score, a medium reputation score (e.g., a good reputation score), or a high reputation score. After the one or more devices (e.g., seeker devices) receive the association message (e.g., signal) transmitted from the device (e.g., donor device), the device (e.g., donor device) can form an association with the one or more devices (e.g., seeker devices).

During operation of the process 500, during the advertising capabilities step 550 of the association setup phase 510, the device (e.g., donor device) may transmit (e.g., broadcast) to the other devices (e.g., seeker devices) within the association an advertisement message (e.g., a signal) indicating one or more capabilities of the device (e.g., donor device) available for sharing with the other devices (e.g., seeker devices). In one or more examples, the one or more capabilities may include, but are not limited to, a compute capability (e.g., an artificial intelligence (AI)/machine learning (ML) capability), a sensing (e.g., perception) capability, a connectivity and/or communication capability, an energy capability, a collaborative (or distributed) computing capability, an energy capability, a power (e.g., battery) capability, memory and/or storage capability, hardware capabilities such as hardware components or blocks on a system-on-chip (SoC) (e.g., GPU, NPU, cache memory, etc.), any combination thereof, and/or other capabilities. The advertising message may also indicate an exchange system to be used for the sharing of the one or more capabilities and/or a reputation score for the device (e.g., donor device) transmitting the advertisement message.

During operation of the process 500, during the sharing policy step 560 of the association setup phase 510, the advertisement message may also indicate a sharing policy for the sharing of the one or more capabilities of the device (e.g., donor device) with the other devices (e.g., seeker devices). The sharing policy may indicate a certain limit in amount (e.g., in energy or computational speed) and duration (e.g., amount of time) for which the device (e.g., donor device) is willing to share its one or more capabilities with the other devices (e.g., seeker devices). For example, the device (e.g., donor device) may indicate that the device (e.g., donor device) can share its energy (e.g., power) with the other devices (e.g., seeker devices), until the device (e.g., donor device) has depleted its own battery supply down to a 50 percent battery level, such that the device (e.g., donor device) still has enough battery supply to be able to withstand any possible dynamic surge demands (e.g., dynamic demands in power for complex computing needs). For another example, the device (e.g., donor device), which may be capable of a one gigabit downlink speed, may indicate that the device (e.g., donor device) can share a 100 megabits downlink speed, which can be sufficient for most downlinks, with the other devices (e.g., seeker devices). The sharing policy may also indicate a certain threshold in the reputation score for the other devices (e.g., seeker devices) that the device (e.g., donor device) will share its capabilities. For example, the device (e.g., donor device) may indicate that the device (e.g., donor device) will only share its capabilities with other devices (e.g., seeker devices) that have a high reputation score.

During operation of the process 500, during the participate in association step 570 of the activity phase 520, the device (e.g., donor device) and the other devices (e.g., seeker devices) may participate within the association for sharing of the capabilities. In one or more examples, the device and other devices may use a protocol for joining an association, which may include a device association and connection security. In some examples, the device (e.g., donor device) may use a protocol for sharing one or more capabilities (e.g., computing, sensing, connectivity, and/or other capabilities) with the other devices (e.g., seeker devices). During the association step 570, the device (e.g., donor device) and the other devices (e.g., seeker devices) may perform a transaction (e.g., an exchange, such as a barter or charge) for the sharing and receiving of the one or more capabilities.

During operation of the process 500, during the disassociation step 580 of the teardown phase 530, the device (e.g., donor device) may indicate to the other devices (e.g., seeker devices) the criteria for a graceful withdrawal (e.g., a graceful termination of the sharing). In some examples, the device (e.g., donor device) may indicate to the other devices (e.g., seeker devices) a handling for ungraceful exits (e.g., ungraceful terminations of sharing). In one or more examples, the device (e.g., donor device) may detect a security breach during the sharing of its capabilities with the other devices (e.g., seeker devices). In some examples, during the teardown phase 530, the devices (e.g., seeker devices) receiving the capabilities from the device (e.g., donor device) may update the reputation score of the device (e.g., donor device) based on their experience with receiving the capabilities from the device (e.g., donor device). In one or more examples, the device (e.g., donor device) may update and/or reset the exchange value (e.g., fee amount), if needed.

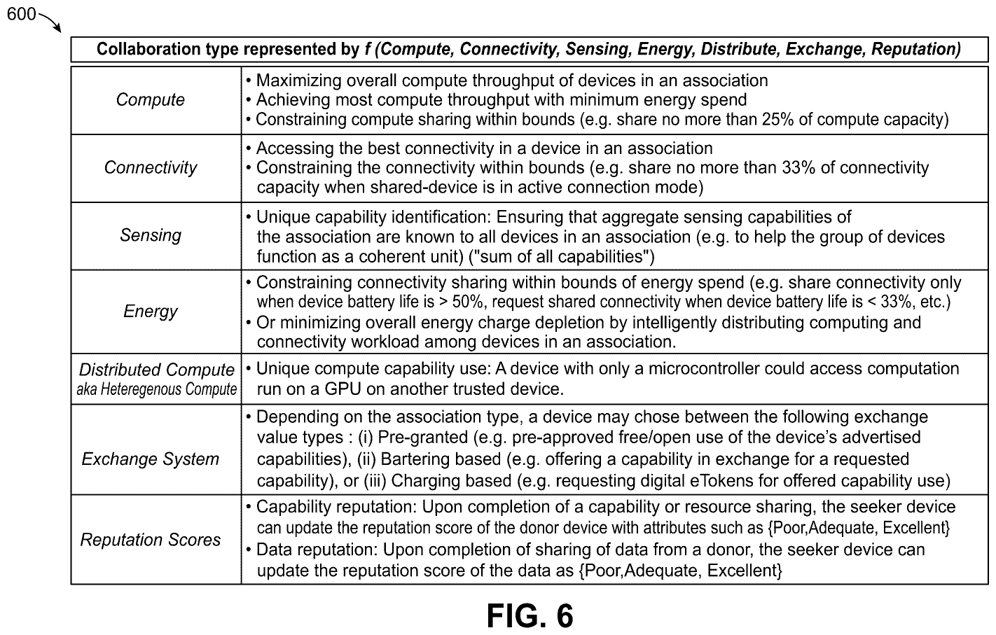

FIG. 6 is a table 600 illustrating examples of attributes for sharing underutilized computing, sensing, connectivity, and/or energy capabilities. In table 600, the first column contains different attributes, which include compute, connectivity, sensing, energy, distributed compute (e.g., heterogenous compute), exchange system, and reputation scores. In table 600, the second column contains criteria (e.g., for each of the attributes) for multi-variate collaboration types for overall collaboration optimization within the associations (e.g., device group associations) for sharing of capabilities. In one or more examples, the criteria may include, but is not limited to, a maximum criteria, a minimum criteria, a constraint criteria, a best mode criteria, and/or a unique capability criteria.

In one or more examples, devices may participate in different collaboration types (e.g., modes) based on the associations (e.g., permanent association or ad hoc association) that they are associated. In some examples, a collaboration type may be a function of the attributes:
f(Compute, Connectivity, Sensing, Energy, Distributed, Exchange, Reputation {Capability, Data})

In one or more examples, a user's device in different associations can support various different collaboration modes. For example, when the device is within a personal device association, the device (e.g., smartphone) may choose to share all of its capabilities, except for a distributed computing capability, with devices having a pre-granted exchange and a high reputation score (e.g., where the symbol ϕ can be used to denote a missing attribute):
f(Compute, Connectivity, Sensing, Energy, ϕ, PG, {High, High})

For another example, when the device is within a friends and family association, the device (e.g., smartphone) may choose to share all of its capabilities, except for a compute capability and a distributed computing capability, with devices having a pre-granted exchange and a high reputation score:
f(ϕ, Connectivity, Sensing, Energy, ϕ, PG, {High, High})

For example, when the device is within a home device association, the device (e.g., smartphone) may choose to share all of its capabilities, except for a connectivity capability, with device that have a pre-granted exchange and a high reputation score:
f(Compute, ϕ, Sensing, Energy, Distributed, PG, {High, High})

For another example, when the device is within a workplace environment, the device (e.g., smartphone) may choose to share all of its capabilities, except for a compute capability and a connectivity capability, with devices that have a pre-granted exchange or can use a barter exchange and have a varying reputation score:
f(ϕ, ϕ, Sensing, Energy, Distributed, {PG|barter}, {Medium, High})

For another example, when the device is within an ad hoc association, the device (e.g., smartphone) may choose to share only its connectivity capability and sensing capability with devices that have a pre-granted exchange, or can use a barter exchange or a charge exchange, and have a varying reputation score:
f(ϕ, Connectivity, Sensing, ϕ, ϕ, {PG, barter, charge}, {Medium, High})

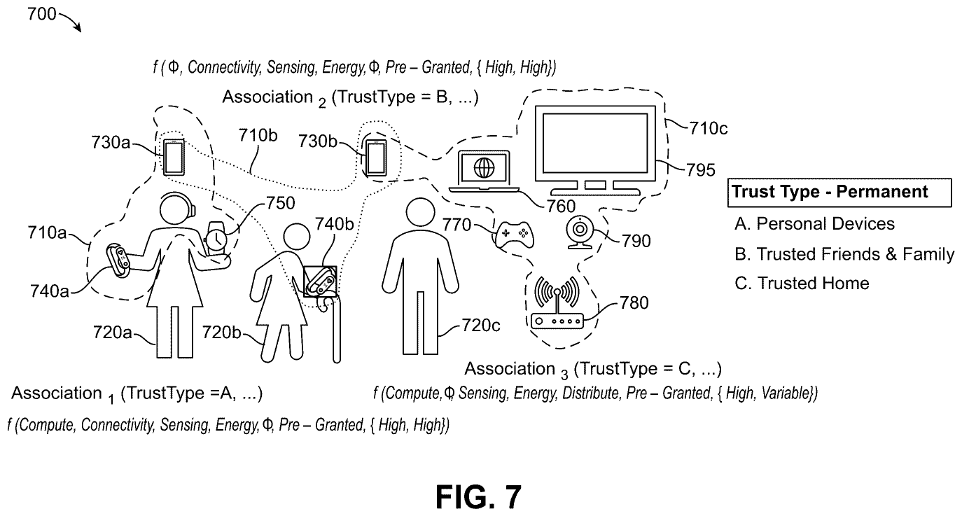

FIG. 7 shows an example of multiple concurrent association types (e.g., permanent associations), where devices are within more than one association with multiple collaboration types. In particular, FIG. 7 is a diagram illustrating an example of a system 700 including devices with permanent associations with each other. In FIG. 7, three users 720a, 720b, 720c are shown. In one or more examples, the system 700 may include more or less number of users than as shown in FIG. 7.

Each user 720a, 720b, 720c is associated with devices that are participating within an association 710a, 710b, 710c. The devices can include UEs in some cases. For example, device 740a (which is associated with user 720a) in the form of a smart wristband, device 730a (which is associated with user 720a) in the form of a smartphone, and device 750 (which is associated with user 720a) in the form of a smartwatch are participating within a first association 710a (e.g., which is of trust type A, which is a personal device association). Device 740b (which is associated with user 720b) in the form of a smart wristband, the device 730a (which is associated with user 720a) in the form of a smartphone, and device 730b (which is associated with user 720c) in the form of a smartphone are participating within a second association 710b (e.g., which is of trust type B, which is a friends and family association). The device 730b (which is associated with user 720c and is located within a house) in the form of a smartphone, device 760 (which is located within the house) in the form of a laptop computer, device 770 (which is located within the house) in the form of a game controller, device 780 (which is located within the house) in the form of a computer router, device 790 (which is located within the house) in the form of a smart camera, and device 795 (which is located within the house) in the form of a smart television are participating within a third association 710c (e.g., which is of trust type C, which is a home device association). In one or more examples, the system 700 may include more or less number and/or different types of associations and/or devices than as shown in FIG. 7.

In one or more examples, users 720a and 720c are a couple, and user 720b is a mother of one of the users 720a, 720c. As previously mentioned, devices 730a, 730b, 740b are within the second association 710b (e.g., which is of trust type B, which is a friends and family association) and, as such, the devices 730a, 730b, 740b can share capabilities with each other. In some examples, the device 730a (which is associated with user 720a) and the device 730b (which is associated with user 720c) can be connected to the device 740a (which is associated with user 720b), and the device 740b can share sensing capabilities with the devices 730a, 730b such that the users 720a, 720c can monitor via their devices 730a, 730b sensor data (e.g., health data, such as heartbeat, etc.) captured by the device 740b that is associated with the user 720b.

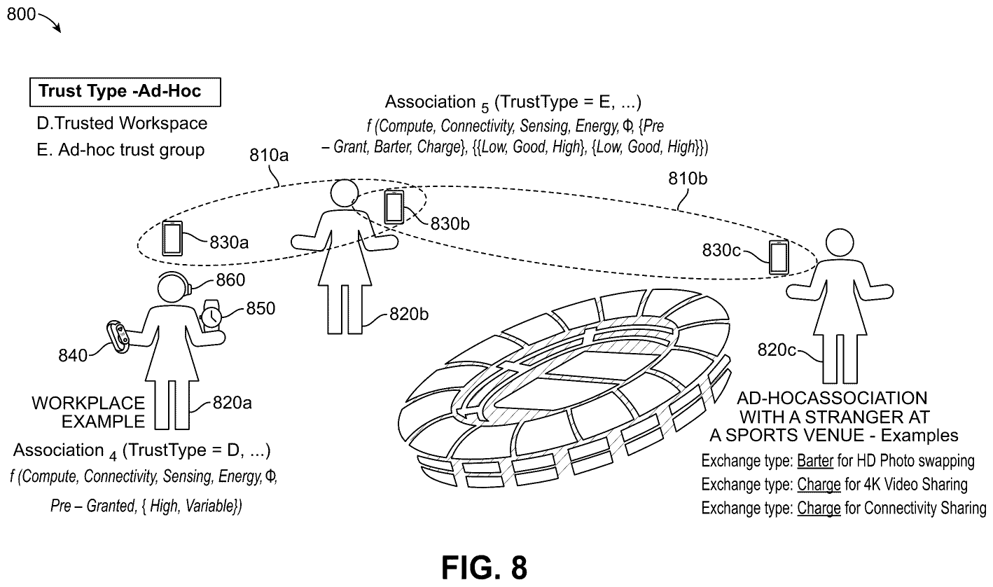

FIG. 8 shows an example of multiple concurrent association types (e.g., ad hoc association), where devices are within more than one association with multiple collaboration types. In particular, FIG. 8 is a diagram illustrating an example of a system 800 including devices with ad hoc associations with each other. In FIG. 8, three users 820a, 820b, 820c are shown. In one or more examples, the system 800 may include more or less number of users than as shown in FIG. 8.

Each user 820a, 820b, 820c is associated with devices that are participating within an association 810a, 810b. For example, device 830a (which is associated with user 820a) in the form of a smartphone and device 830b (which is associated with user 820b) in the form of a smartphone are participating within a first association 810a (e.g., which is of trust type D, which is a workplace environment association). The device 830b (which is associated with user 820b) in the form of a smartphone and device 830c (which is associated with user 820c) in the form of a smartphone are participating within a second association 810b (e.g., which is of trust type E, which is an ad hoc association). In FIG. 8, device 840 in the form of a smart wristband, device 850 in the form of a smartwatch, and device 860 in the form of a smart audio microphone and headset are also associated with user 820a. In one or more examples, the system 800 may include more or less number and/or different types of associations and/or devices than as shown in FIG. 8.

In one or more examples, users 820a and 820b are co-workers located within a workplace environment, and user 820c is a stranger located at a sporting event. As previously mentioned, the devices 830a, 830b are within the first association 810a (e.g., which is of trust type D, which is a workplace environment association) and, as such, the devices 830a, 830b can share capabilities with each other. The devices 830b, 830c are within the second association 810b (e.g., which is of trust type E, which is an ad hoc association) and, as such the devices 830b, 830c can share capabilities with each other. In one or more examples, the device 830c can share capabilities with the device 830a via the device 830b, because the device 830b is located within both of the associations 810a, 810b of the devices 830a, 830c. In some examples, the device 830c can share sensing capabilities (e.g., images of the game at the stadium) with device 830a via the device 830b.

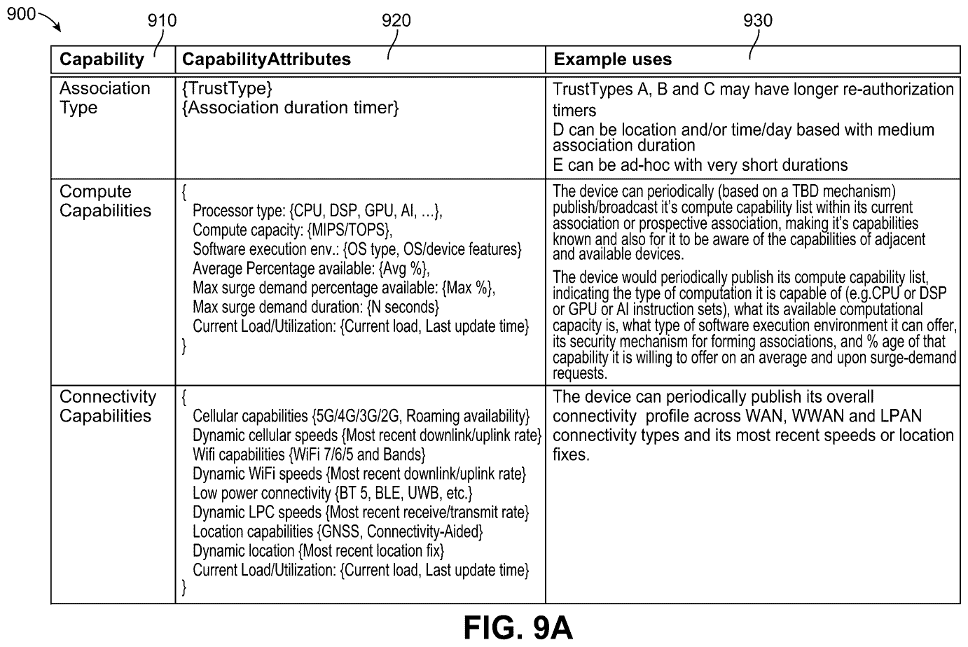

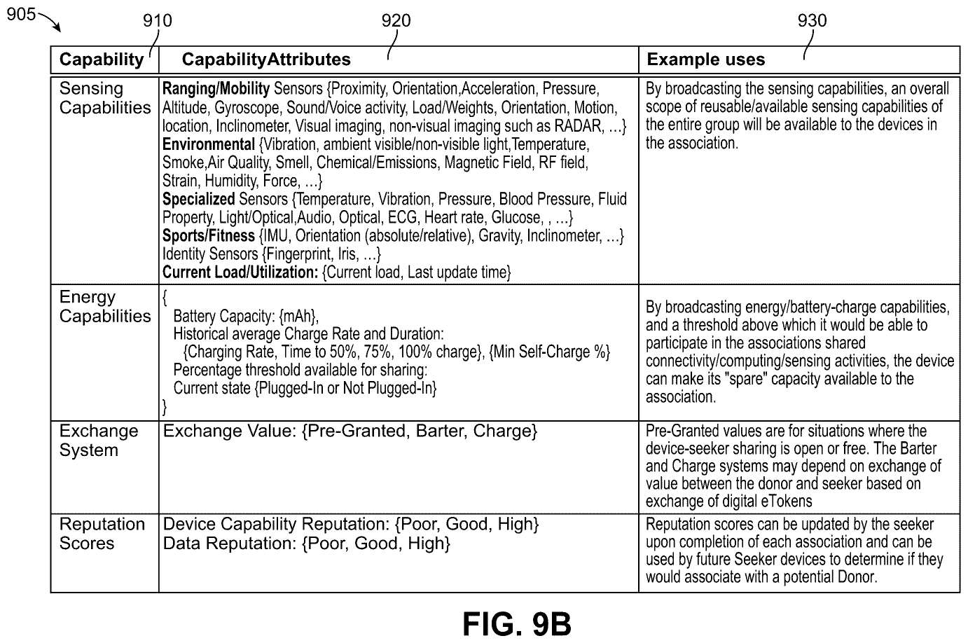

FIGS. 9A and 9B are tables 900, 905 that together illustrate examples of capabilities for sharing amongst devices. The tables 900, 905 include a capability 910 column, a capability attributes 920 column, and an example uses 930 column. In particular, the tables 900, 905 show capability attributes 920 and example uses 930 for each different capability 910.

In one or more aspects, devices within permanent associations (e.g., personal device association, friends and family association, and home device association) may set up and form connections (e.g., links) between the devices to share capabilities. In one or more examples, a donor device (DDx) may advertise its intent to share its capabilities, resources, and/or data through broadcast messages (e.g., advertisement messages), which may be transmitted via a BLE broadcast. The donor device may advertise its intent to participate by broadcasting a “device capability” message (e.g., an advertisement message) on a periodic basis, manually, and/or when position changes are detected. Other devices (e.g., seeker devices) that are located nearby the donor device can receive this broadcast message. After receiving the broadcast message, these devices (e.g., seeker devices) can determine if there are any capability elements (e.g., compute, connectivity, sensing, battery power, and/or distributed/heterogenous compute) that they would like to seek augmentation and take advantage of for their current task assignments (e.g., for their current processes running).

A seeker device (SDx) can respond to the donor device (e.g., by sending a response message requesting one or more capabilities from the donor device), and an inter-process communication (IPC) Protocol can be established for requesting a particular capability element (e.g., compute, connectivity, sensing, battery power, distributed/heterogenous compute, capability, power or battery, memory, storage, hardware any combination thereof, and/or other capabilities) set from the donor device. After the donor device receives the response message, the donor device can send an acknowledgement message to the seeker device indicating an acknowledgement of sharing of the requested capabilities with the seeker device.

In one or more examples, the donor device can operate on a point-to-point (P2P) or a point-to-multipoint (P2MP) mode, when operating with a single seeker device or multiple seeker devices, respectively, depending upon how the system implemented. Similarly, seeker devices can work with peer-to-peer or peer-to-multi-peer associations following the same protocols.

Once confirmation (e.g., the acknowledgement message) is received by the seeker device from the donor device, a secure channel or intermediate cloud exchange (e.g., shared memory, disk file) repository can be established between the donor device and the seeker device to communicate for the length of the association (e.g., for a fixed duration, a custom duration, or a permanent duration of time).

In one or more examples, for cases where collaborative computing is being used, “units” of work (e.g., associated with the one or more requested capabilities) can be shipped through the secure channel or cloud repository from the donor device to the seeker device. The secure channel or cloud repository can be used to store assigned work units, intermediate work products, and/or status messages associated with the sharing of the one or more capabilities. In one or more examples, multi-threaded, hyperthreading, scheduling concepts, and/or preemptive multitasking may be employed for the sharing of the capabilities. The seeker device can collect the finished work “units” from the central repository and/or from the donor device, and can complete the overall task that the seeker device broke down into multiple work streams. In some examples, the seeker device can work in parallel with multiple donor devices simultaneously, if needed to breakdown a main task into multiple work streams, each needing separate unique resources. Each session can be independent of each other, and can be established over a dedicated secure channel or cloud repository link.

In one or more examples, the seeker device or the donor device can decide to terminate a session, after it completes the task or when trigger conditions (e.g., a battery level, a timer expiration, or a loss of proximity between the two devices) are met to dissolve the established connections.

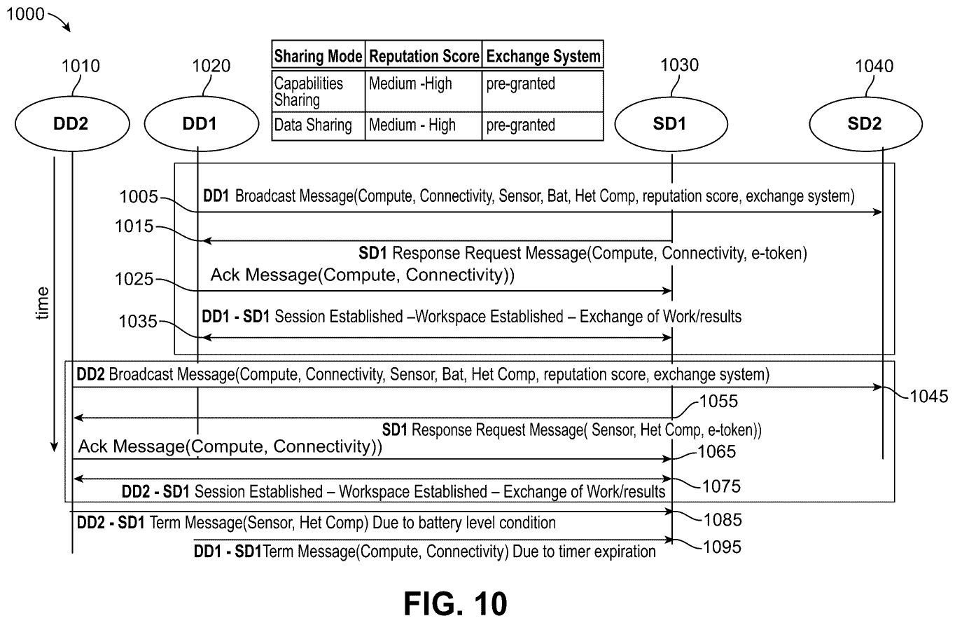

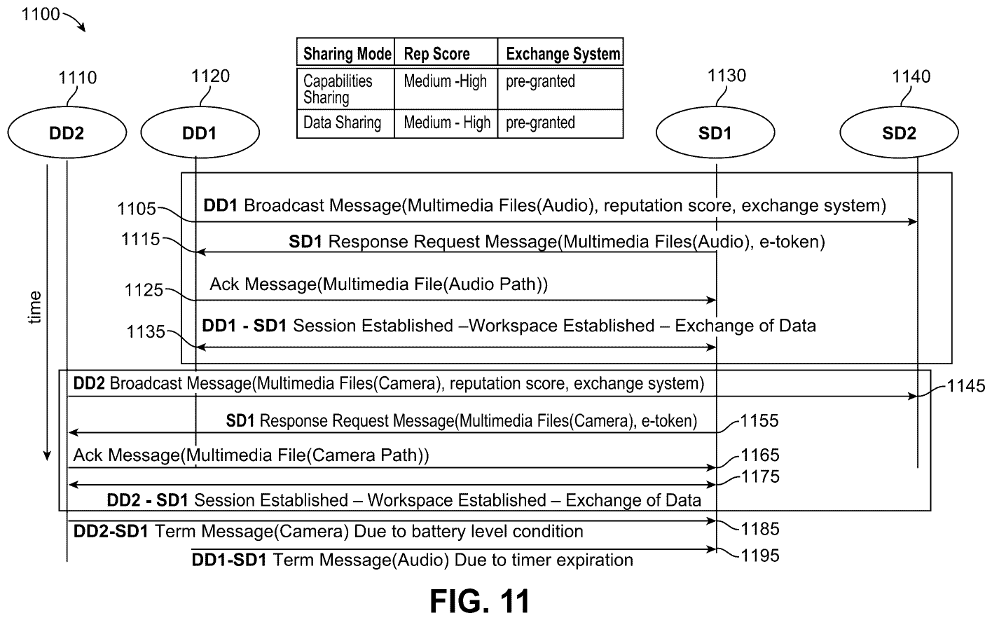

FIGS. 10 and 11 show examples of signaling that can be used for setting up and forming connections (e.g., links) between donor devices and seeker devices within permanent associations for sharing capabilities. In particular, FIG. 10 is a diagram illustrating an example of signaling 1000 for devices with permanent associations for sharing capabilities and resources. In FIG. 10, donor device (DD1) 1020, donor device (DD2) 1010, seeker device (SD1) 1030, and seeker device (SD2) 1040 are shown, and are within a permanent association. The donor device (DD1) 1020, donor device (DD2) 1010, seeker device (SD1) 1030, and seeker device (SD2) 1040 may have a medium to high reputation score (e.g., a medium to high level of trustworthiness) for sharing their capabilities, a pre-granted exchange system (e.g., an already established system) for sharing their capabilities, a medium to high reputation score for sharing their acquired (e.g., sensed) data (e.g., images or video data), and a pre-granted exchange system for sharing their acquired data.

During operation of the signaling 1000 of FIG. 10, for the signal 1005, the donor device (DD1) 1020 can transmit (e.g., broadcast) a message (e.g., an advertisement message) to the seeker device (SD1) 1030 and the seeker device (SD2) 1040. In one or more examples, the advertisement message can indicate one or more capabilities (e.g., compute, connectivity, sensor, battery power, heterogenous computing, power or battery, memory, storage, hardware any combination thereof, and/or other capabilities) of the donor device (DD1) 1020 available for sharing with the seeker device (SD1) 1030 and the seeker device (SD2) 1040, as well as can indicate a reputation score for the donor device (DD1) 1020 and an exchange system to use for the sharing. After receiving the advertisement message, for the signal 1015, the seeker device (SD1) 1030 can send a response message requesting one or more of the capabilities (e.g., compute, connectivity, and/or other capabilities) from the donor device (DD1) 1020 and indicating an exchange system (e.g., e-token exchange) to use. After receiving the response message, for the signal 1025, the donor device (DD1) 1020 can send an acknowledgement message indicating an acknowledgment of the receipt of the response message and of providing (e.g., sharing) the one or more requested capabilities to the seeker device (SD1) 1030. After sending the acknowledgment message, at link 1035, the donor device (DD1) 1020 can establish a connection (e.g., a link) with the seeker device (SD1) 1030 for sharing the one or more requested capabilities with the seeker device (SD1) 1030 (e.g., for exchanging work and/or results).

During operation of the signaling 1000 of FIG. 10, for the signal 1045, the donor device (DD2) 1010 can transmit (e.g., broadcast) a message (e.g., an advertisement message) to the seeker device (SD1) 1030 and the seeker device (SD2) 1040. In one or more examples, the advertisement message can indicate one or more capabilities (e.g., compute, connectivity, sensor, battery power, heterogenous computing, etc.) of the donor device (DD2) 1010 available for sharing with the seeker device (SD1) 1030 and the seeker device (SD2) 1040, as well as can indicate a reputation score for the donor device (DD2) 1010 and an exchange system to use for the sharing. After receiving the advertisement message, for the signal 1055, the seeker device (SD1) 1030 can send a response message requesting one or more of the capabilities (e.g., sensor, heterogenous computing, etc.) from the donor device (DD2) 1010 and indicating an exchange system (e.g., e-token exchange) to use. After receiving the response message, for the signal 1065, the donor device (DD2) 1010 can send an acknowledgement message indicating an acknowledgment of the receipt of the response message and of providing (e.g., sharing) the one or more requested capabilities to the seeker device (SD1) 1030. After sending the acknowledgment message, at link 1075, the donor device (DD2) 1010 can establish a connection (e.g., a link) with the seeker device (SD1) 1030 for sharing the one or more requested capabilities with the seeker device (SD1) 1030 (e.g., for exchanging work and/or results).

At signal 1085, after the battery level of the donor device (DD2) 1010 has dropped down to a specified threshold level, the donor device (DD2) 1010 can send a termination message to the seeker device (SD1) 1030 to terminate the connection (e.g., terminate the link 1075). At signal 1095, after a timer has expired, the donor device (DD1) 1020 can send a termination message to the seeker device (SD1) 1030 to terminate the connection (e.g., the link 1035).

FIG. 11 is a diagram illustrating an example of signaling 1100 for devices with permanent associations for exchanging data. In FIG. 11, donor device (DD1) 1120, donor device (DD2) 1110, seeker device (SD1) 1130, and seeker device (SD2) 1140 are shown, and are within a permanent association. The donor device (DD1) 1120, donor device (DD2) 1110, seeker device (SD1) 1130, and seeker device (SD2) 1140 may have a medium to high reputation score (e.g., a medium to high level of trustworthiness) for sharing their capabilities, a pre-granted exchange system (e.g., an already established system) for sharing their capabilities, a medium to high reputation score for sharing their acquired (e.g., sensed) data (e.g., images or video data), and a pre-granted exchange system for sharing their acquired data.

During operation of the signaling 1100 of FIG. 11, for the signal 1105, the donor device (DD1) 1120 can transmit (e.g., broadcast) a message (e.g., an advertisement message) to the seeker device (SD1) 1130 and the seeker device (SD2) 1140. In one or more examples, the advertisement message can indicate data (e.g., multimedia files of audio) acquired by the donor device (DD1) 1120 available for sharing with the seeker device (SD1) 1130 and the seeker device (SD2) 1140, as well as can indicate a reputation score for the donor device (DD1) 1120 and an exchange system to use for the sharing. After receiving the advertisement message, for the signal 1115, the seeker device (SD1) 1130 can send a response message requesting data (e.g., multimedia files of audio) from the donor device (DD1) 1120 and indicating an exchange system (e.g., e-token exchange) to use. After receiving the response message, for the signal 1125, the donor device (DD1) 1120 can send an acknowledgement message indicating an acknowledgment of the receipt of the response message and of providing (e.g., sharing) the data (e.g., multimedia file audio path) to the seeker device (SD1) 1130. After sending the acknowledgment message, at link 1135, the donor device (DD1) 1120 can establish a connection (e.g., a link) with the seeker device (SD1) 1130 for sharing the data with the seeker device (SD1) 1130 (e.g., for exchanging the data).

During operation of the signaling 1100 of FIG. 11, for the signal 1145, the donor device (DD2) 1110 can transmit (e.g., broadcast) a message (e.g., an advertisement message) to the seeker device (SD1) 1130 and the seeker device (SD2) 1140. In one or more examples, the advertisement message can indicate data (e.g., multimedia files from a camera) of the donor device (DD2) 1110 available for sharing with the seeker device (SD1) 1130 and the seeker device (SD2) 1140, as well as can indicate a reputation score for the donor device (DD2) 1110 and an exchange system to use for the sharing. After receiving the advertisement message, for the signal 1155, the seeker device (SD1) 1130 can send a response message requesting the data (e.g., multimedia files from a camera) from the donor device (DD2) 1110 and indicating an exchange system (e.g., e-token exchange) to use. After receiving the response message, for the signal 1165, the donor device (DD2) 1110 can send an acknowledgement message indicating an acknowledgment of the receipt of the response message and of providing (e.g., sharing) the data to the seeker device (SD1) 1130. After sending the acknowledgment message, at link 1175, the donor device (DD2) 1110 can establish a connection (e.g., a link) with the seeker device (SD1) 1130 for sharing the data with the seeker device (SD1) 1130 (e.g., for exchanging the data).

At signal 1185, after the battery level of the donor device (DD2) 1110 has dropped down to a specified threshold level, the donor device (DD2) 1110 can send a termination message to the seeker device (SD1) 1130 to terminate the connection (e.g., terminate the link 1175). At signal 1195, after a timer has expired, the donor device (DD1) 1120 can send a termination message to the seeker device (SD1) 1130 to terminate the connection (e.g., the link 1135).

In one or more aspects, devices within ad hoc associations (e.g., workplace environment association and public congregation association) may set up and form connections (e.g., links) between the devices to share capabilities. In one or more examples, a donor device (DDx) can advertise its intent to capabilities/resources/data through BLE broadcast messages (e.g., advertisement messages). In some examples, the donor device can advertise its intent to participate by broadcasting a “device capability” message (e.g., an advertisement message) on a periodic basis, manually, or when position changes are detected.

Other devices (e.g., seeker devices) that are nearby the donor device have the ability to receive this broadcast message (e.g., which can include the reputation score of the donor device and the exchange system information), and can determine if there are any capabilities (e.g., compute, connectivity, sensing, battery power, distributed/heterogenous compute, power or battery, memory, storage, hardware any combination thereof, and/or other capabilities) or data that these devices (e.g., seeker devices) would like to use and take advantage of for their current task assignments or access to data from the donor device.

In one or more examples, a seeker device (SDx) can respond to the donor device (DDx) by sending a response message, and an IPC Protocol can be established for requesting particular capability elements (e.g., compute, connectivity, sensing, battery power, distributed/heterogeneous compute, power or battery, memory, storage, hardware any combination thereof, and/or other capabilities) or access to data from the donor device.

In one or more examples, in permanent association use cases, the reputation score of a donor device can be set to high (e.g., indicating a trusted device), and the exchange system can be set to pre-granted (e.g., a free or no-charge exchange system), as these devices are more likely to be a part of a home or enterprise network.

In one or more examples, in ad hoc use cases, where a seeker device could be any random device that receives the broadcast message, access to the resources, capabilities, or data may be granted in exchange for credits (e.g., e-tokens). The seeker device can verify the reputation score (e.g., a medium or high reputation score) and exchange system (e.g., a barter or charge-based exchange system), and can make a decision to complete the transaction by exchanging the appropriate credits for access to the resources or data as set by the donor device. The seeker device can send the appropriate e-tokens to the donor device to express its intent and participate in the transaction.

The donor device (DDx) can operate on a P2P or a P2MP mode, when operating with a single seeker device or multiple seeker devices, depending upon the implementation of the system. Similarly, the seeker devices can work with peer-to-peer or peer-to-multi-peer associations, but following the same protocols.

Once Confirmation (e.g., via an acknowledgement message) is received by the seeker device from the donor device and the donor device has received the appropriate e-tokens from the seeker device, a secure channel or intermediate cloud exchange (e.g., shared memory or disk file) repository can be established between the donor device and the seeker device for the length of the association (e.g., for a fixed duration, custom duration, or permanent duration of time).

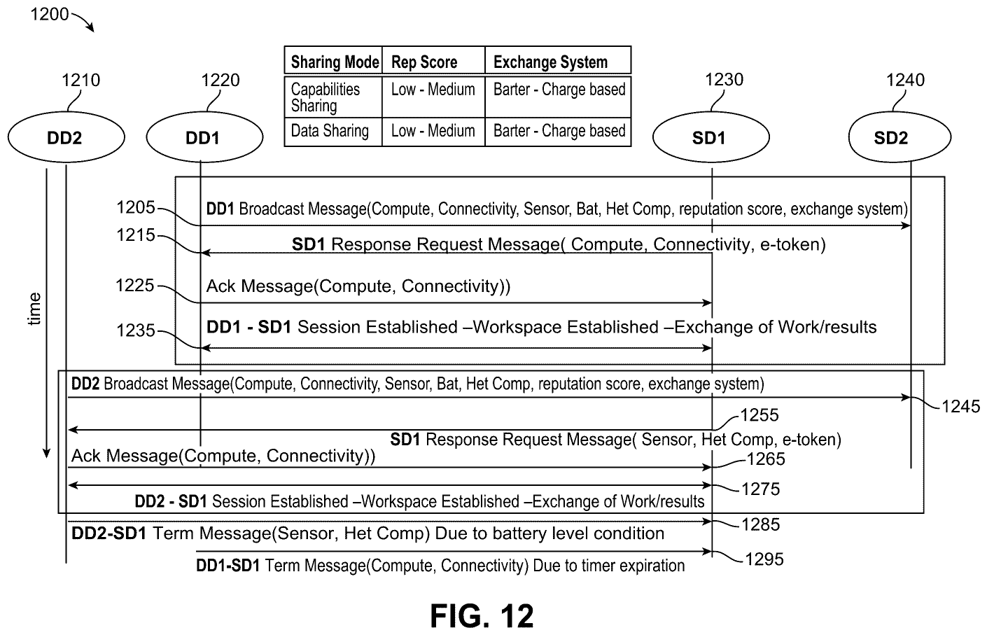

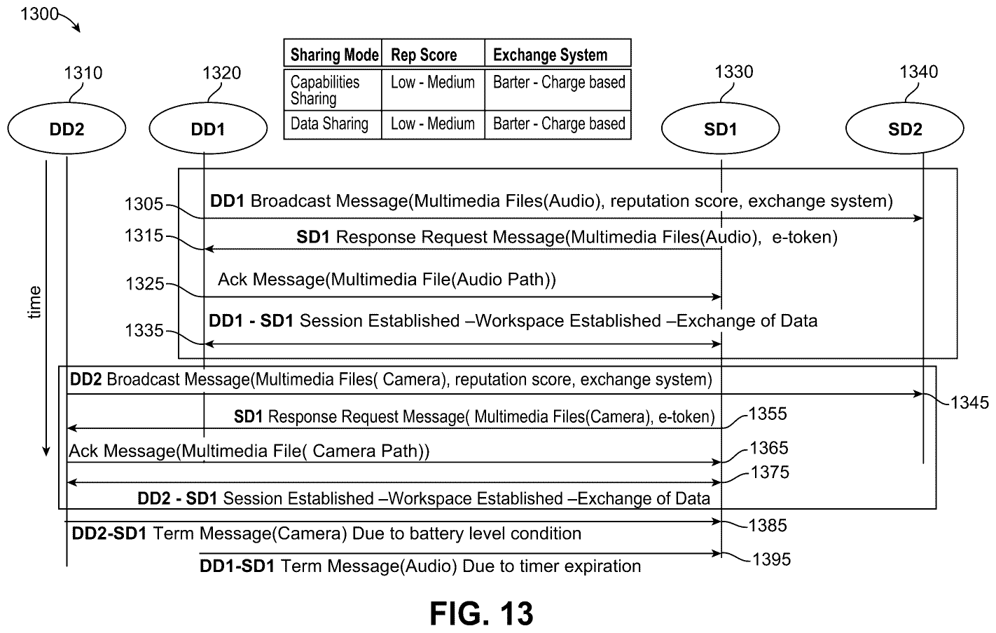

FIGS. 12 and 13 show examples of signaling that can be used for setting up and forming connections (e.g., links) between donor devices and seeker devices within ad hoc associations for sharing capabilities. In particular, FIG. 12 is a diagram illustrating an example of signaling 1200 for devices with ad hoc associations for sharing capabilities and resources. In FIG. 12, donor device (DD1) 1220, donor device (DD2) 1210, seeker device (SD1) 1230, and seeker device (SD2) 1240 are shown, and are within an ad hoc association. The donor device (DD1) 1220, donor device (DD2) 1210, seeker device (SD1) 1230, and seeker device (SD2) 1240 may have a low to medium reputation score (e.g., a low to medium level of trustworthiness) for sharing their capabilities, a barter or a charged based exchange system for sharing their capabilities, a low to medium reputation score for sharing their acquired (e.g., sensed) data (e.g., images or video data), and a barter or a charged based exchange system for sharing their acquired data.

During operation of the signaling 1200 of FIG. 12, for the signal 1205, the donor device (DD1) 1220 can transmit (e.g., broadcast) a message (e.g., an advertisement message) to the seeker device (SD1) 1230 and the seeker device (SD2) 1240. In one or more examples, the advertisement message can indicate one or more capabilities (e.g., compute, connectivity, sensor, battery power, heterogenous computing, power or battery, memory, storage, hardware any combination thereof, and/or other capabilities) of the donor device (DD1) 1220 available for sharing with the seeker device (SD1) 1230 and the seeker device (SD2) 1240, as well as can indicate a reputation score for the donor device (DD1) 1220 and an exchange system to use for the sharing. After receiving the advertisement message, for the signal 1215, the seeker device (SD1) 1230 can send a response message requesting one or more of the capabilities (e.g., compute and connectivity) from the donor device (DD1) 1220 and indicating an exchange system (e.g., e-token exchange) to use. After receiving the response message, for the signal 1225, the donor device (DD1) 1220 can send an acknowledgement message indicating an acknowledgment of the receipt of the response message and of providing (e.g., sharing) the one or more requested capabilities to the seeker device (SD1) 1230. After sending the acknowledgment message, at link 1235, the donor device (DD1) 1220 can establish a connection (e.g., a link) with the seeker device (SD1) 1230 for sharing the one or more requested capabilities with the seeker device (SD1) 1230 (e.g., for exchanging work and/or results).

During operation of the signaling 1200 of FIG. 12, for the signal 1245, the donor device (DD2) 1210 can transmit (e.g., broadcast) a message (e.g., an advertisement message) to the seeker device (SD1) 1230 and the seeker device (SD2) 1240. In one or more examples, the advertisement message can indicate one or more capabilities (e.g., compute, connectivity, sensor, battery power, heterogenous computing, power or battery, memory, storage, hardware any combination thereof, and/or other capabilities) of the donor device (DD2) 1210 available for sharing with the seeker device (SD1) 1230 and the seeker device (SD2) 1240, as well as can indicate a reputation score for the donor device (DD2) 1210 and an exchange system to use for the sharing. After receiving the advertisement message, for the signal 1255, the seeker device (SD1) 1230 can send a response message requesting one or more of the capabilities (e.g., sensor and heterogenous computing) from the donor device (DD2) 1210 and indicating an exchange system (e.g., e-token exchange) to use. After receiving the response message, for the signal 1265, the donor device (DD2) 1210 can send an acknowledgement message indicating an acknowledgment of the receipt of the response message and of providing (e.g., sharing) the one or more requested capabilities to the seeker device (SD1) 1230. After sending the acknowledgment message, at link 1275, the donor device (DD2) 1210 can establish a connection (e.g., a link) with the seeker device (SD1) 1230 for sharing the one or more requested capabilities with the seeker device (SD1) 1230 (e.g., for exchanging work and/or results).

At signal 1285, after the battery level of the donor device (DD2) 1210 has dropped down to a specified threshold level, the donor device (DD2) 1210 can send a termination message to the seeker device (SD1) 1230 to terminate the connection (e.g., terminate the link 1275). At signal 1295, after a timer has expired, the donor device (DD1) 1220 can send a termination message to the seeker device (SD1) 1230 to terminate the connection (e.g., the link 1235).

FIG. 13 is a diagram illustrating an example of signaling 1300 for devices with ad hoc associations for exchanging data. In FIG. 13, donor device (DD1) 1320, donor device (DD2) 1310, seeker device (SD1) 1330, and seeker device (SD2) 1340 are shown, and are within an ad hoc association. The donor device (DD1) 1320, donor device (DD2) 1310, seeker device (SD1) 1330, and seeker device (SD2) 1340 may have a low to medium reputation score (e.g., a low to medium level of trustworthiness) for sharing their capabilities, a barter or a charge based exchange system for sharing their capabilities, a low to medium reputation score for sharing their acquired (e.g., sensed) data (e.g., images or video data), and a barter or a charge based exchange system for sharing their acquired data.

During operation of the signaling 1300 of FIG. 13, for the signal 1305, the donor device (DD1) 1320 can transmit (e.g., broadcast) a message (e.g., an advertisement message) to the seeker device (SD1) 1330 and the seeker device (SD2) 1340. In one or more examples, the advertisement message can indicate data (e.g., multimedia files of audio) acquired by the donor device (DD1) 1320 available for sharing with the seeker device (SD1) 1330 and the seeker device (SD2) 1340, as well as can indicate a reputation score for the donor device (DD1) 1320 and an exchange system to use for the sharing. After receiving the advertisement message, for the signal 1315, the seeker device (SD1) 1330 can send a response message requesting data (e.g., multimedia files of audio) from the donor device (DD1) 1320 and indicating an exchange system (e.g., e-token exchange) to use. After receiving the response message, for the signal 1325, the donor device (DD1) 1320 can send an acknowledgement message indicating an acknowledgment of the receipt of the response message and of providing (e.g., sharing) the data (e.g., multimedia file audio path) to the seeker device (SD1) 1330. After sending the acknowledgment message, at link 1335, the donor device (DD1) 1320 can establish a connection (e.g., a link) with the seeker device (SD1) 1330 for sharing the data with the seeker device (SD1) 1330 (e.g., for exchanging the data).

During operation of the signaling 1300 of FIG. 13, for the signal 1345, the donor device (DD2) 1310 can transmit (e.g., broadcast) a message (e.g., an advertisement message) to the seeker device (SD1) 1330 and the seeker device (SD2) 1340. In one or more examples, the advertisement message can indicate data (e.g., multimedia files from a camera) of the donor device (DD2) 1310 available for sharing with the seeker device (SD1) 1330 and the seeker device (SD2) 1340, as well as can indicate a reputation score for the donor device (DD2) 1310 and an exchange system to use for the sharing. After receiving the advertisement message, for the signal 1355, the seeker device (SD1) 1330 can send a response message requesting the data (e.g., multimedia files from a camera) from the donor device (DD2) 1310 and indicating an exchange system (e.g., e-token exchange) to use. After receiving the response message, for the signal 1365, the donor device (DD2) 1310 can send an acknowledgement message indicating an acknowledgment of the receipt of the response message and of providing (e.g., sharing) the data to the seeker device (SD1) 1330. After sending the acknowledgment message, at link 1375, the donor device (DD2) 1310 can establish a connection (e.g., a link) with the seeker device (SD1) 1330 for sharing the data with the seeker device (SD1) 1330 (e.g., for exchanging the data).

At signal 1385, after the battery level of the donor device (DD2) 1310 has dropped down to a specified threshold level, the donor device (DD2) 1310 can send a termination message to the seeker device (SD1) 1330 to terminate the connection (e.g., terminate the link 1375). At signal 1395, after a timer has expired, the donor device (DD1) 1320 can send a termination message to the seeker device (SD1) 1330 to terminate the connection (e.g., the link 1335).

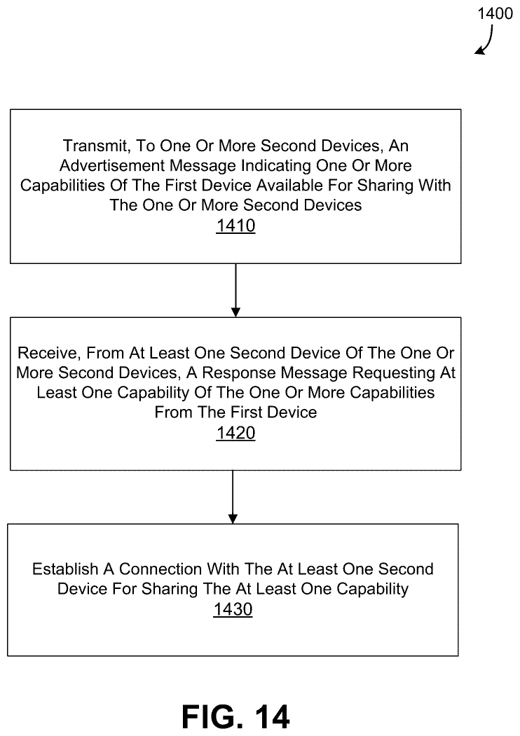

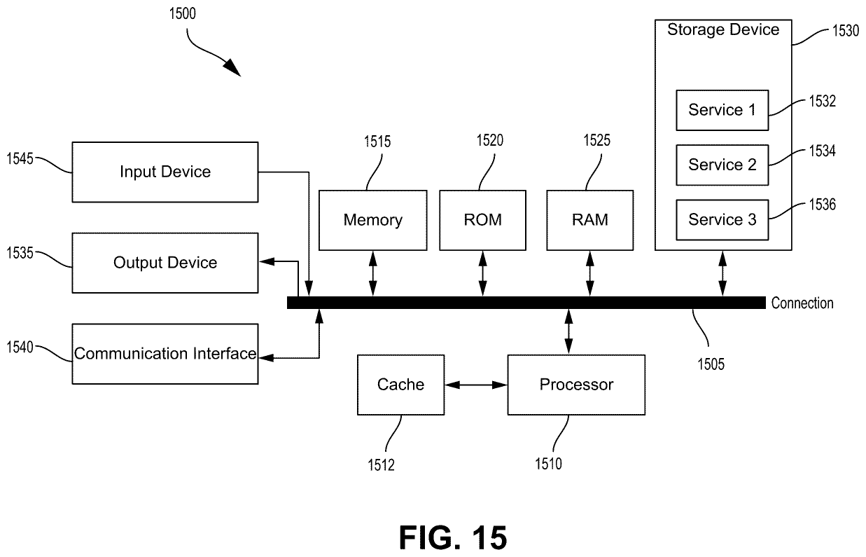

FIG. 14 is a flow chart illustrating an example of a process 1400 for alleviating (e.g., via sharing) underutilized computing, sensing, connectivity, and/or energy capabilities. The process 1400 can be performed by a first device (e.g., a computing device or computing system 1500 of FIG. 15) or by a component or system (e.g., a chipset) of the first device. The operations of the process 1400 may be implemented as software components that are executed and run on one or more processors (e.g., the controller/processor 280 of FIG. 2, the processor 484 and/or the DSP(s) 482 of FIG. 4, the processor 1510 of FIG. 15 or other processor(s)). Further, the transmission and reception of signals by the first device in the process 1400 may be enabled, for example, by one or more antennas and/or one or more transceivers such as one or more wireless transceiver(s) (e.g., one or more of the DEMODs/MODs 254a to 254r, MIMO detector 256, receive processor 258, transmit processor 264, and/or TX-MIMO processor 266 of FIG. 2, one or more of the SIM(s) 474, modem(s) 476, and/or wireless transceiver(s) 478 of FIG. 4, the communication interface 1540 of FIG. 15, and/or other antenna(s) and/or transceiver(s)).

At block 1410, the first device (or component thereof) can transmit (or output for transmission), to one or more second devices, an advertisement message indicating one or more capabilities of the first device available for sharing with the one or more second devices. As described herein, the one or more capabilities can include any the one or more capabilities that can be shared between devices. For instance, the one or more capabilities can include a computing capability, a connectivity capability, a sensing capability, an energy capability, a distributed computing capability, a power capability, a battery capability, a memory capability, a storage capability, a hardware capability, any combination thereof, and/or other capability or capabilities. In some cases, the computing capability can include an artificial intelligence (AI)/machine learning (ML) capability, a computing capacity capability (e.g., an amount of processor and/or memory the first device can use), etc.

In some cases, the advertisement message further indicates an exchange system for sharing the one or more capabilities. For instance, the exchange system can be a pre-grant exchange, a barter exchange, or a charge exchange. In some aspects, the advertisement message further indicates a reputation score indicating a level of trustworthiness for the first device.

At block 1420, the first device (or component thereof) can receive, from at least one second device of the one or more second devices, a response message requesting at least one capability of the one or more capabilities from the first device.

At block 1430, the first device (or component thereof) can establish a connection with the at least one second device for sharing the at least one capability. In some aspects, the first device (or component thereof) can form a respective device group association with each second device of the one or more second devices. For instance, a device group association can be a permanent association or an ad hoc association, as described herein. In some cases, the first device (or component thereof) can establish the connection via one or more third devices. In some examples, the first device (or component thereof) can form a respective device group association with each third device of the one or more third devices.

In some cases, the network device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1400 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1400 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 15 is a block diagram illustrating an example of a computing system 1500, which may be employed for alleviating (e.g., via sharing) underutilized computing, sensing, connectivity, energy, power or battery, memory, storage, hardware any combination thereof, and/or other capabilities. In particular, FIG. 15 illustrates an example of computing system 1500, which can be for example any computing device making up internal computing system, a remote computing system, a camera, or any component thereof in which the components of the system are in communication with each other using connection 1505. Connection 1505 can be a physical connection using a bus, or a direct connection into processor 1510, such as in a chipset architecture. Connection 1505 can also be a virtual connection, networked connection, or logical connection.

In some aspects, computing system 1500 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1500 includes at least one processing unit (CPU or processor) 1510 and connection 1505 that communicatively couples various system components including system memory 1515, such as read-only memory (ROM) 1520 and random access memory (RAM) 1525 to processor 1510. Computing system 1500 can include a cache 1512 of high-speed memory connected directly with, in close proximity to, or integrated as part of processor 1510.

Processor 1510 can include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, computing system 1500 includes an input device 1545, which can represent any number of input mechanisms, such as a microphone for speech, a touch-sensitive screen for gesture or graphical input, keyboard, mouse, motion input, speech, etc. Computing system 1500 can also include output device 1535, which can be one or more of a number of output mechanisms. In some instances, multimodal systems can enable a user to provide multiple types of input/output to communicate with computing system 1500.

Computing system 1500 can include communications interface 1540, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1540 may also include one or more range sensors (e.g., LIDAR sensors, laser range finders, RF radars, ultrasonic sensors, and infrared (IR) sensors) configured to collect data and provide measurements to processor 1510, whereby processor 1510 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1530 can include software services, servers, services, etc., that when the code that defines such software is executed by the processor 1510, it causes the system to perform a function. In some aspects, a hardware service that performs a particular function can include the software component stored in a computer-readable medium in connection with the necessary hardware components, such as processor 1510, connection 1505, output device 1535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smartphones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. A first device for sharing device capabilities, the first device comprising: at least one memory; and at least one processor coupled to the at least one memory and configured to: output, for transmission to one or more second devices, an advertisement message indicating one or more capabilities of the first device available for sharing with the one or more second devices; receive, from at least one second device of the one or more second devices, a response message requesting at least one capability of the one or more capabilities from the first device; and establish a connection with the at least one second device for sharing the at least one capability. Aspect

Aspect 2. The first device of Aspect 1, wherein the one or more capabilities comprise at least one of a computing capability, a connectivity capability, a sensing capability, an energy capability, a distributed computing capability, a power capability, a battery capability, a memory capability, a storage capability, or a hardware capability.

Aspect 3. The first device of any one of Aspects 1 or 2, wherein the advertisement message further indicates an exchange system for sharing the one or more capabilities.

Aspect 4. The first device of Aspect 3, wherein the exchange system is one of a pre-grant exchange, a barter exchange, or a charge exchange.

Aspect 5. The first device of any one of Aspects 1 to 4, wherein the advertisement message further indicates a reputation score indicating a level of trustworthiness for the first device.

Aspect 6. The first device of any one of Aspects 1 to 5, wherein the at least one processor is configured to form a respective device group association with each second device of the one or more second devices.

Aspect 7. The first device of Aspect 6, wherein the device group association is one of a permanent association or an ad hoc association.

Aspect 8. The first device of any one of Aspects 1 to 7, wherein the connection is established via one or more third devices.

Aspect 9. The first device of Aspect 8, wherein the at least one processor is configured to form a respective device group association with each third device of the one or more third devices.

Aspect 10. A method for sharing device capabilities, the method comprising: transmitting, by a first device to one or more second devices, an advertisement message indicating one or more capabilities of the first device available for sharing with the one or more second devices; receiving, by the first device from at least one second device of the one or more second devices, a response message requesting at least one capability of the one or more capabilities from the first device; and establishing, by the first device, a connection with the at least one second device for sharing the at least one capability.

Aspect 11. The method of Aspect 10, wherein the one or more capabilities comprise at least one of a computing capability, a connectivity capability, a sensing capability, an energy capability, a distributed computing capability, a power capability, a battery capability, a memory capability, a storage capability, or a hardware capability.

Aspect 12. The method of any one of Aspects 10 or 11, wherein the advertisement message further indicates an exchange system for sharing the one or more capabilities.

Aspect 13. The method of Aspect 12, wherein the exchange system is one of a pre-grant exchange, a barter exchange, or a charge exchange.

Aspect 14. The method of any one of Aspects 10 to 13, wherein the advertisement message further indicates a reputation score indicating a level of trustworthiness for the first device.

Aspect 15. The method of any one of Aspects 10 to 14, further comprising forming, by the first device, a respective device group association with each second device of the one or more second devices.

Aspect 16. The method of Aspect 15, wherein the device group association is one of a permanent association or an ad hoc association.

Aspect 17. The method of any one of Aspects 10 to 16, wherein the connection is established via one or more third devices.

Aspect 18. The method of Aspect 17, further comprising forming, by the first device, a respective device group association with each third device of the one or more third devices.

Aspect 19. A non-transitory computer-readable medium of a first device having stored thereon instructions that, when executed by one or more processors, cause the one or more processors to: output, for transmission to one or more second devices, an advertisement message indicating one or more capabilities of the first device available for sharing with the one or more second devices; receive, from at least one second device of the one or more second devices, a response message requesting at least one capability of the one or more capabilities from the first device; and establish a connection with the at least one second device for sharing the at least one capability.

Aspect 20. The non-transitory computer-readable medium of Aspect 19, wherein the one or more capabilities comprise at least one of a computing capability, a connectivity capability, a sensing capability, an energy capability, a distributed computing capability, a power capability, a battery capability, a memory capability, a storage capability, or a hardware capability.

Aspect 21. The non-transitory computer-readable medium of any one of Aspects 19 or 20, wherein the advertisement message further indicates an exchange system for sharing the one or more capabilities.

Aspect 22. The non-transitory computer-readable medium of Aspect 21, wherein the exchange system is one of a pre-grant exchange, a barter exchange, or a charge exchange.

Aspect 23. The non-transitory computer-readable medium of any one of Aspects 19 to 22, wherein the advertisement message further indicates a reputation score indicating a level of trustworthiness for the first device.

Aspect 24. The non-transitory computer-readable medium of any one of Aspects 19 to 23, further comprising instructions that, when executed by the one or more processors, cause the one or more processors to form a respective device group association with each second device of the one or more second devices.

Aspect 25. The non-transitory computer-readable medium of Aspect 24, wherein the device group association is one of a permanent association or an ad hoc association.

Aspect 26. The non-transitory computer-readable medium of any one of Aspects 19 to 25, wherein the connection is established via one or more third devices.

Aspect 27. The non-transitory computer-readable medium of Aspect 26, further comprising instructions that, when executed by the one or more processors, cause the one or more processors to form a respective device group association with each third device of the one or more third devices.

Aspect 28. An apparatus for generating virtual content in a distributed system, the apparatus including one or more means for performing operations according to any of Aspects 10 to 18.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A first device for sharing device capabilities, the first device comprising:
at least one memory; and
at least one processor coupled to the at least one memory and configured to:
output, for transmission to one or more second devices, an advertisement message indicating one or more capabilities of the first device available for sharing with the one or more second devices;
receive, from at least one second device of the one or more second devices, a response message requesting at least one capability of the one or more capabilities from the first device; and
establish a connection with the at least one second device for sharing the at least one capability.

2. The first device of claim 1, wherein the one or more capabilities comprise at least one of a computing capability, a connectivity capability, a sensing capability, an energy capability, a distributed computing capability, a power capability, a battery capability, a memory capability, a storage capability, or a hardware capability.

3. The first device of claim 1, wherein the advertisement message further indicates an exchange system for sharing the one or more capabilities.

4. The first device of claim 3, wherein the exchange system is one of a pre-grant exchange, a barter exchange, or a charge exchange.

5. The first device of claim 1, wherein the advertisement message further indicates a reputation score indicating a level of trustworthiness for the first device.

6. The first device of claim 1, wherein the at least one processor is configured to form a respective device group association with each second device of the one or more second devices.

7. The first device of claim 6, wherein the device group association is one of a permanent association or an ad hoc association.

8. The first device of claim 1, wherein the connection is established via one or more third devices.

9. The first device of claim 8, wherein the at least one processor is configured to form a respective device group association with each third device of the one or more third devices.

10. A method for sharing device capabilities, the method comprising:
transmitting, by a first device to one or more second devices, an advertisement message indicating one or more capabilities of the first device available for sharing with the one or more second devices;
receiving, by the first device from at least one second device of the one or more second devices, a response message requesting at least one capability of the one or more capabilities from the first device; and
establishing, by the first device, a connection with the at least one second device for sharing the at least one capability.

11. The method of claim 10, wherein the one or more capabilities comprise at least one of a computing capability, a connectivity capability, a sensing capability, an energy capability, a distributed computing capability, a power capability, a battery capability, a memory capability, a storage capability, or a hardware capability.

12. The method of claim 10, wherein the advertisement message further indicates an exchange system for sharing the one or more capabilities.

13. The method of claim 12, wherein the exchange system is one of a pre-grant exchange, a barter exchange, or a charge exchange.

14. The method of claim 10, wherein the advertisement message further indicates a reputation score indicating a level of trustworthiness for the first device.

15. The method of claim 10, further comprising forming, by the first device, a respective device group association with each second device of the one or more second devices.

16. The method of claim 15, wherein the device group association is one of a permanent association or an ad hoc association.

17. The method of claim 10, wherein the connection is established via one or more third devices.

18. The method of claim 17, further comprising forming, by the first device, a respective device group association with each third device of the one or more third devices.

19. A non-transitory computer-readable medium of a first device having stored thereon instructions that, when executed by one or more processors, cause the one or more processors to:
output, for transmission to one or more second devices, an advertisement message indicating one or more capabilities of the first device available for sharing with the one or more second devices;
receive, from at least one second device of the one or more second devices, a response message requesting at least one capability of the one or more capabilities from the first device; and
establish a connection with the at least one second device for sharing the at least one capability.

20. The non-transitory computer-readable medium of claim 19, wherein the one or more capabilities comprise at least one of a computing capability, a connectivity capability, a sensing capability, an energy capability, a distributed computing capability, a power capability, a battery capability, a memory capability, a storage capability, or a hardware capability.
